(19) United States
(12) Patent Application Publication
(10) Pub. No.: US 2016/0130458 A1
(43) Pub. Date: May 12, 2016

(54) Antifogging Molecular Films and Methods of Producing Same

(71) Applicants: Nicole HERBOTS, Tempe, AZ (US); Clarizza WATSON, Gilbert, AZ (US); SiO2 Nanotech, Scottsdale, AZ (US)

(72) Inventors: Nicole HERBOTS, Tempe, AZ (US); Clarizza WATSON, Gilbert, AZ (US)

(21) Appl. No.: 14/896,397

(22) PCT Filed: Jun. 5, 2014
(86) PCT No.: PCT/US14/41191

§ 371 Date: Dec. 6, 2015

Related U.S. Application Data
(60) Provisional application No. 61/831,373, filed on Jun. 5, 2013.
(60) Provisional application No. 61/894,905, filed on Oct. 23, 2013.

(51) Int. Cl. C09D 101/28; B05D 1/28; B05D 1/18; C09D 101/02; B05D 1/02

(52) U.S. Cl. CPC C09D 101/28; C09D 101/02; B05D 1/02; B05D 1/18; B05D 1/28

(57) ABSTRACT

Compositions are disclosed containing a solvated viscoelastic polymeric gel diluted into purified water which can be usefully applied to any surface, including a hydrophobic surface, to act, for example, as an antifogging coating with minimal optical distortion and excellent transparency. Also provided are methods of making and applying the compositions to surfaces such as window shields, mirrors, goggles, and helmets as well as methods of producing a fog-free surface by nano-etching the surface.

### CROSS REFERENCE TO RELATED APPLICATIONS

This application claims the benefit of U.S. Provisional Patent Application No. 61/831,373, filed Jun. 5, 2013, and U.S. Provisional Patent Application No. 61/894,905, filed Oct. 23, 2013, and incorporates the disclosure of each application by reference thereto.

### TECHNICAL FIELD

This application relates to the field of coatings that prevent fogging on solid surfaces without altering the characteristics of the covered surface. The coatings may be used on devices and equipment for sports and recreation, the medical field, and military and industrial safety applications. Such devices and equipment include windows and mirrors of automobiles, motorcycles, boats, airplanes, and trains, intraocular lenses, endoscopic/laparoscopic lenses, contact lenses for visual correction, medical surfaces, and medical and surgical tools.

### BACKGROUND

Transparent substrates such as glass are used for vehicular window glass, architectural window glass, lens, goggles, etc. In circumstances where the transparent substrate is used in a high-humidity place or at a boundary of a large temperature difference and a large humidity difference, fogging occurs due to condensation on the surface. For example, in a high-humidity rainy season or in a low-temperature winter, window and mirror fogging in a vehicle is inevitable. To remove the fogging, a dehumidifying wind is generally required to blow against the window to restore visibility, such as a defogger on an automobile. However, drivers still have to wait a few minutes for it to effectively address the fog. To avoid fogging on vehicle windows and mirrors, it is desirable to provide a film that prevents fogging without affecting the qualities of the coated surface, such as optical transmission. Pre-treating windshields and/or windows on any method of transportation (e.g., buses, cars, trains, airplanes, boats, etc.) with the present invention can ensure a clear field of vision.

This need also exists for other transparent surfaces found in, for example, lenses, goggles, and facial masks or shields. Products exposed to conditions causing fogging include those used in a number of applications. These include eye protection in manufacturing or industrial safety applications, sports and recreation, laboratories, educational activities, home and garden tasks, and in medical, military, mining, and construction.

In sports and recreation applications, there is a need for reliable eye protection. An issue with eye protection in contacts sports is that while eye protection can prevent any traumatic eye injury that may end their athletic career, fog on the visor or vision wear makes the eye protection apparatus a safety hazard in itself. And for certain contact sports where eye protection is optional, such as in American football, athletes opt to not wear eye protection because the inconvenience of fog limits their performance. For swimmers, goggles immediately fog upon swimming with them, and almost all swimmers with goggles will deal with limited vision. Most swimmers have a habit of wiping their lenses with their fingers upon finishing laps or competition. This habit can be broken with the present invention because there would no longer be a need to “wipe the fog away.” Fogging is also significant with ski and snowboarding vision wear, because of the temperature gradient between the ambient environment, and body temperature. Specifically for these winter sports, there are even gloves that are manufactured with rubber blades to “wipe” fog from ski/snowboarding goggles.

Furthermore, there are many occupations that are required to comply with OSHA standards and regulations for safety, including, but not limited to fields such as mining, construction, manufacturing, scientific research in laboratories, etc. Most eye injuries in the workplace occur because safety vision wear was not worn. Prevention is a lot more inexpensive then addressing a traumatic eye injury. Eye injuries can result in lawsuits, extensive treatment, visual impairment, and even blindness.

U.S. patent application Ser. No. 13/674,307 (hereinafter '307 application) describes an emulsion that physically changes the surface topography so that condensation behavior can be controlled. The result in the '307 application is a hydrophilic surface that manipulates water droplets so that the water droplets form a thin translucent film on the hydrophilic surface. The '307 application describes a wet anti-fog technology, where the emulsion is applied when the surface requires an antifogging coating and should not be dried on the surface. When the emulsion of the '307 application is dried, the polymers come out of the solution and precipitate so that the coated surface is no longer optically transparent and fails to maintain optical quality. Specifically, the emulsion described in the '307 application is optimized for temporary application and for ease of application. The emulsion described in the '307 application was designed for medical applications, including but not limited to vitro-retinal surgery as well as endoscopic and laparoscopic procedures and surgeries. Thus the emulsion described in the '307 application does not permanently coat the surfaces with anti-fog technology. Accordingly, there is need for a dry permanent anti-fog technology that manipulates water so the water droplets form a thin translucent film on a surface rather than produce fogging on the surface while maintaining optical quality.

### SUMMARY

The present invention provides a composition comprising a mixture of (a) a solvated viscoelastic polymeric gel, comprising a viscoelastic polymer having a molecular weight of between about 20,000 Da and about 4,000,000 Da; and (b) purified water; wherein the volume ratio of (a) to (b) is between about 1:1 and about 1:5 and the composition has a conductivity of less than about 250 μS/m. In some embodiments, the ratio of (a) to (b) is between about 1:2 and about 1:3. In some embodiments, the purified water has resistivity of about of between about 60 kΩ-cm to about 17.9 MΩ-cm; more specifically the purified water preferably has resistivity of about 2 MΩ-cm. The composition of the present invention may comprise between 0.0003 wt % and 10 wt % of the viscoelastic polymer.

For some embodiments of the composition, the solvated viscoelastic polymeric gel comprises a viscoelastic polymer having a molecular weight of between about 20,000 Da and about 500,000 Da or between about 20,000 Da and about 200,000 Da. For some aspects, solvated viscoelastic polymeric gel comprises a viscoelastic polymer that is at least 60% fully hydrated. In some aspects, the viscosity of the solvated viscoelastic polymeric gel is about 500 cP to about 5,000 cP, or more specifically about 1,000 cP to about 4,000 cP.

In some aspects of the composition, the solvated viscoelastic polymeric gel may be homogenous. The solvated viscoelastic polymeric gel may comprise cellulose ester or a cellulose ether. The cellulose ester is selected from the group consisting of cellulose acetate, cellulose triacetate, cellulose butyrate, cellulose propionate, cellulose phthalate, cellulose nitrate, cellulose sulfate, cellulose phosphate, cellulose acetate propionate, cellulose acetate butyrate, cellulose acetate phthalate, and cellulose nitrate acetate. And the cellulose ether is selected from the group consisting of methyl cellulose, ethyl cellulose, ethyl methyl cellulose, benzyl cellulose, hydroxyethyl cellulose, hydroxypropyl cellulose (HPC), hydroxyethyl methyl cellulose, hydroxypropyl methyl cellulose (HPMC), ethyl hydroxyethyl cellulose, and carboxymethyl cellulose (CMC). The solvated viscoelastic polymeric gel may also comprise a basic cellulose monomer with the chemical formula C₃₂H₆₀O₁₉ and a molecular weight of 748.8 grams/mole in the stoichiometry C₆H₇O₂(OH)ₓ(OCH₃)_{y}(OC₃H₇)_{z}, wherein x+y+z=3. In other embodiments, the solvated viscoelastic polymeric gel comprises glycosaminoglycan. Glycosaminoglycan is selected from the group consisting of hyaluronan, heparan sulfate, heparin, keratan sulfate, dermatan sulfate, and chondroitin sulfate.

Also provided is a method of producing an antifogging solid dry film comprising: (a) forming a solvated viscoelastic polymeric gel comprising a viscoelastic polymer having a molecular weight of between about 20,000 Da and about 4,000,000 Da; (b) generating an emulsion comprising the solvated viscoelastic polymeric gel and purified water wherein the volume ratio of the gel to the purified water is between about 1:1 and about 1:5 and the emulsion has a conductivity of less than about 250 μS/m; (c) applying the emulsion to a surface; and (d) drying the emulsion on the surface to produce the antifogging solid dry film. In some embodiments, the ratio of the viscoelastic polymeric gel and the purified water is between about 1:2 and about 1:3. In some embodiments, the purified water has resistivity of between about 60 kΩ-cm to about 17.9 MΩ-cm; more specifically the purified water preferably has resistivity of about of about 2 MΩ-cm. For some aspects of the method, the viscoelastic polymeric gel comprises a cellulose ester or a cellulose ether. In other aspects, the viscoelastic polymeric gel comprises a glycosaminoglycan.

For the methods discussed above, the steps (c) applying the emulsion to the surface and (d) drying the emulsion on the surface to produce the antifogging solid dry film may be repeated to produce multiple coats of the emulsion on the surface. Furthermore, applying the emulsion to the surface may comprises immersing the surface in the emulsion, impressing the emulsion onto the surface with a roller, spraying the emulsion onto the surface, showering or jetting the emulsion onto the surface, pouring the emulsion onto the surface, or brushing the emulsion onto the surface. When applying the emulsion to the surface comprises immersing the surface in the emulsion and drawing the surface out of the emulsion, the surface should be moved at a rate of between about 1 mm/s and about 1 m/s, more specifically, between about 1 mm/s and between about 1 cm/s.

In all of the methods disclosed above, drying the emulsion on the surface is performed at a temperature of from about 0° C. to about 48° C., more specifically, from about 5° C. to about 15° C. In some embodiments, the method further comprises applying ink or paint to the antifogging solid dry film. The ink may is selected from the group consisting of an offset ink, a flexographic ink, an energy-curable ink, a gravure ink, a letterpress ink, a specialty ink, and combinations thereof. The energy-curable ink is selected from the group consisting of an ultraviolet (UV) ink and an electron beam (EB) ink.

The present invention also provides a method of applying an antifogging solid dry film comprising attaching an antifogging solid dry film to a surface with a binding agent, wherein the binding agent consists of one of the following: an emulsion comprising the composition of claim 1, an optically satisfactory gluing agent, or water. The method may further comprise lifting the antifogging solid dry film from the surface, wherein the antifogging solid dry film may be applied to a second surface with a binding agent. For this embodiment, the binding agent consists of one of the following: an emulsion comprising the composition of claim 1, an optically satisfactory gluing agent, or water.

Additionally, the present invention provides devices comprising an antifogging coating, where the antifogging coating comprises the composition of the present invention. In some embodiments of the devices, the antifogging coating is on a windshield or mirror of an automobile, motorcycle, boat, airplane, or train. In other embodiments, the antifogging coating coats a transparent portion of goggles, a camera lens, a corrective lens, a facial mask, a facial shield, a helmet, a visor, an endoscope, a laparoscope, an athroscope, or an intraocular lens. In still other embodiments, the antifogging coating coats a surface of a bottle or package. For these devices of the present invention, the antifogging coating may further comprise a layer of transparent film. The layer of transparent film may comprises a material selected from the group consisting of cellophane, cellulose acetate, poly(methyl methacrylate), polycarbonate, polyethylene, polyethylene terephthalate, polylactic acid, polyvinyl butyral, and combinations thereof. In these devices of the present invention, ink or paint may be applied to the antifogging coating. The ink or paint is selected from the group consisting of an offset ink, a flexographic ink, an energy-curable ink, a gravure ink, a letterpress ink, a specialty ink, and combinations thereof. The energy-curable ink is selected from the group consisting of an ultraviolet (UV) ink and an electron beam (EB) ink.

The present invention further provides a method of producing a fog-free surface comprising treating a surface to create a texture with a horizontal maximum feature of less than about 200 nm and an average roughness root mean square of less than about 0.4 nm, wherein the texture prevents water molecules from forming a fog on the surface. The method may further comprise treating the surface with a hydrophilic molecular adsorbate, wherein the hydrophilic molecular adsorbate forces the water molecules to interact with the surface to form a continuous film without any optically detectable air. The hydrophilic molecular adsorbate may comprise a viscoelastic polymer of the composition of the present invention; more specifically, the hydrophilic molecular adsorbate is a polymer comprising polyethylene or hydroxypropylmethylcellulose. Treating a surface to create a texture with a horizontal maximum feature of less than about 200 nm and an average roughness root mean square of less than about 0.4 nm may be accomplished in a liquid phase or a vapor phase of a treatment agent. The treatment agent is selected from the group comprising hydrofluoric acid, buffered hydrofluoric acid, nitric acid, hydrogen peroxide, phosphoric acid, buffered oxide etch, potassium hydroxide, ethylenediamine pyrocatechol, tetramethylammonium hydroxide, aqua regia, sulfuric acid, iodine and potassium iodide solution, hydrochloric acid, citric acid, acetic acid, or any combinations thereof. In some preferred embodiments, the treatment agent is hydrofluoric acid.

### BRIEF DESCRIPTION OF THE DRAWINGS

FIG. 1 depicts an example of the Tyndall effect to detect light scattering and broadening of a laser beam to check gel quality after completion of the gelling process prior to creating the emulsion with purified water.

FIG. 2 depicts an example of the impact of cooling temperature on gelling.

FIG. 3 depicts an example of the drying process after immersion of a material in the emulsion.

FIG. 4 depicts a comparison of fog nucleation on swim goggles, with the bottom goggle lens (401) having no coating and the top goggle lens (402) having a dried coating.

FIG. 5 depicts an example of how to conduct the optical measurements and an example of the optical improvement with the coating. Panel A depicts the scattering of a coherent laser beam (503) through the untreated glass panel (501) while Panel B depicts the scattering of the laser light through the treated glass panel (502).

FIG. 6 depicts a comparison of resistance to chemical damage on glass with the right glass XX (601) having no treatment and the left glass XXIV (602) having treatment.

### DETAILED DESCRIPTION OF THE INVENTION

As used herein, the verb “comprise” as is used in this description and in the claims and its conjugations are used in its non-limiting sense to mean that items following the word are included, but items not specifically mentioned are not excluded. In addition, reference to an element by the indefinite article “a” or “an” does not exclude the possibility that more than one of the elements are present, unless the context clearly requires that there is one and only one of the elements. The indefinite article “a” or “an” thus usually means “at least one”.

As used herein, the term “about” refers to a +/−10% variation from the nominal value. It is to be understood that such a variation is always included in any given value provided herein, whether or not it is specifically referred to.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. The contents of all references, patents, and published patent applications cited throughout this application, as well as the Figures, are incorporated herein by reference in their entirety for all purposes.

The publications discussed herein are provided solely for their disclosure prior to the filing date of the present application. Nothing herein is to be construed as an admission that the present invention is not entitled to antedate such publication by virtue of prior invention.

All of the embodiments each of the aspects of the invention can be used together and are suitable for combining in any combination except where the context clearly dictates otherwise. While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

The present invention relates to antifogging coatings that prevent fogging on solid surfaces without altering the characteristics of the coated surface. The present invention uses a dry permanent anti-fog technology that imprints a topography that manipulates water droplets so that the water droplets form a thin translucent film on the hydrophilic surface. Thus the antifogging coatings of the present invention are hydrophilic. The antifogging coatings may be an emulsion applied to a surface. The emulsion-based coating is a wet semi-permanent coating. The antifogging coatings may also be an antifogging solid dry film, which may be created by drying the emulsion that was applied to a surface. The antifogging solid dry film-based coating is a dry permanent coating. Both types of antifogging coatings avoid optical distortion and maintain excellent transparency and visualization. For example, the coatings have about 92%, about 94%, about 96%, and about 99% optical transmission.

The present invention may be used for medical applications, where a temporary anti-fog surface is sufficient. In one embodiment of the invention, the invention can be used in conjunction with any procedure in which coating a hydrophobic surface with the invention would be useful, including but not limited to for acting as an antifogging agent (such as in intraocular lens (IOL) surgical procedures) on medical implants, shunts and surgical supplies to minimize tissue trauma, maximize bio-compatibility, and increase healing. The present invention may also be used for applications when a more permanent anti-fog surface is desired, such as in sports and recreation and military and industrial safety applications. Example uses of the present invention in medical applications include application on IOLs, contact lenses, endoscopes, laparoscopes, arthroscopes, and other medical and surgical surfaces and tools. The present invention can also be applied on oral mirrors and scopes used by dentists and orthodontists. Example uses of the present invention in sports and recreational applications include application on football visors, hockey visors, swimming goggles, scuba goggles, ski/snowboarding goggles, motor sports visors and helmets. Examples uses of the present invention in occupational safety application are application on vision wear, for example on construction/occupational safety glasses, welding face masks, laboratory goggles, and face shields. Example of applications of the present invention in industrial safety are applications on the windows and shields on transportation vehicles such as automobiles, boats, jet skis, motorcycles, trains, and airplanes. The present invention may also be applied on the mirrors of these transportation vehicles.

In one example of the present invention used in medical applications, application of the present invention on silicone IOLs significantly inhibit condensation on silicone IOLs and avoids opacification of the eye lens observed in at least 25% of alternative IOLs. While not being bound by a specific mechanism of action, the inventors believe that application of the present invention to a hydrophobic silicone surface, such as a silicone IOL, creates a biocompatible nanophase on the IOL surface that can maintain a wetting and bonding surface layer comprising a web of polymer strands from the composition of the invention, thereby impeding condensation of the opaque water film.

### Composition

One aspect of the present invention is directed to a composition and a method of producing the composition. The composition may be innocuous, pH neutral, non-toxic, and/or made of food-grade material, and it comprises an emulsion that is optical-grade and transparent. The emulsion may be used for vision and for direct printing applications and may be applied on any surface. The surface includes but are not limited to glass (including Pyrex, boro-silicate, and commercial glasses used in window panes, and for food, drug and cosmetic glass bottling and jars, cerium oxides), polymers (including hydrophobic silicone, silicone, hydrophobic acrylic, polycarbonates), and all materials used in face-shields vision wear, corrective lenses and UV protective goggles and glasses. Applications of the present invention on a surface eliminates droplet formation of any fluid (especially water-based fluids) on these surfaces, for example eliminating fog on vision-wear, lenses windows, car windows, mirrors, windows for readings instruments and adhering inks uniformly in two-dimensional layers without forming visible droplets for direct printing on the surface.

The composition of the present invention comprises a viscoelastic polymeric gel, comprising a viscoelastic polymer having a molecular weight of between about 20,000 Daltons (Da) and about 4,000,000 Da. As used herein, the term “viscoelastic” means that the component exhibits both viscous and elastic properties when undergoing deformation. As used herein, the “molecular weight” of a polymer refers to the weight-averaged molecular weight of the referenced polymer. In one preferred embodiment, the solvated viscoelastic polymeric gel is homogenous. As used herein, the term “homogeneous” is defined as a single polymer type in the gel. In another preferred embodiment, the solvated viscoelastic polymer comprises a combination of two or more polymers.

In other preferred embodiments, the viscoelastic polymer can have a molecular weight of about 40,000 Da to about 4,000,000 Da; preferably between 30,000 Da and 2,000,000 Da, and even more preferably between 40,000 Da and 1,000,000 Da. Lower molecular weights are preferred, such as about 20,000 Da to about 1,000,000 Da, as gravity can cause the polymer to delaminate and detach from a surface on which the composition may be positioned. Thus the viscoelastic polymer in some preferred embodiments have molecular weights of between about 20,000 Da and 500,000 Da, more preferably, about 20,000 Da and 200,000 Da. The viscoelastic polymer may also have a molecular weight of between about 40,000 Da and about 500,000 Da; about 40,000 Da and about 250,000 Da; about 40,000 Da and about 150,000 Da; about 40,000 Da and about 100,000 Da; about 40,000 Da and about 80,000 Da; about 50,000 Da and about 500,000 Da; about 50,000 Da and about 250,000 Da; about 50,000 Da and about 120,000 Da; about 50,000 Da and about 110,000 Da; about 50,000 Da and about 100,000 Da; about 50,000 Da and about 90,000 Da; about 50,000 Da and about 80,000 Da; about 60,000 Da and about 500,000 Da; about 60,000 Da and about 250,000 Da; about 60,000 Da and about 120,000 Da; about 60,000 Da and about 110,000 Da; about 60,000 Da and about 100,000 Da; about 60,000 Da and about 90,000 Da; about 60,000 Da and about 80,000 Da; about 70,000 Da and about 500,000 Da; about 70,000 Da and about 250,000 Da; about 70,000 Da and about 120,000 Da; about 70,000 Da and about 110,000 Da; about 70,000 Da and about 100,000 Da; about 70,000 Da and about 90,000 Da; about 70,000 Da and about 80,000 Da; about 80,000 Da and about 500,000 Da; about 80,000 Da and about 250,000 Da; about 80,000 Da and about 120,000 Da; about 80,000 Da and about 110,000 Da; and about 80,000 Da and about 100,000 Da.

To prevent the viscoelastic polymer from precipitating into an opaque residue, the compositions of the present invention are substantially pure from impurities such as salts or other molecules that would contribute to the electrolytic conductivity of the compositions. Thus, in certain embodiments, the composition of the invention has a conductivity of less than about 1 mS/m, less than about 950 μS/m, less than about 900 μS/m, less than about 850 μS/m, less than about 800 μS/m, less than about 750 μS/m, less than about 700 μS/m, less than about 650 μS/m, less than about 600 μS/m, less than about 550 μS/m, less than about 500 μS/m, less than about 450 μS/m, less than about 400 μS/m, less than about 350 μS/m, less than about 300 μS/m, less than about 250 μS/m, less than about 200 μS/m, less than about 150 μS/m, less than about 100 μS/m, less than about 90 μS/m, less than about 80 μS/m, less than about 70 μS/m, less than about 60 μS/m, less than about 50 μS/m, less than about 40 μS/m, less than about 30 μS/m, less than about 20 μS/m, or less than about 10 μS/m.

The composition of the present invention can be formed by direct hydration of a viscoelastic polymer in water (e.g. purified water), provided that the viscoelastic polymer is well hydrated and does not aggregate. The composition of the present invention can also be formed by an at least two-step process. First, a viscoelastic polymer is fully solvated to form the solvated viscoelastic polymeric gel by addition of an aqueous solution (e.g., water or purified water). Then, an amount of purified water is added to dilute the solvated viscoelastic polymeric gel into a composition of the invention. The dilution of the emulsion can ensure minimum optical distortion and optimal clarity, which cannot be achieved with only a viscoelastic polymeric gel. However, the composition of the present invention can be formed by direct hydration of the viscoelastic polymer in water. Composition form by this one-step process should also conform to the dilution requirements described below.

In certain preferred embodiments, the composition of the invention comprises between about 0.0003 wt % and about 10 wt % viscoelastic polymer. For example, the composition can contain between about 0.0003 wt % and about 5.0 wt %; or between about 0.0003 wt % and about 3.0 wt %; or between about 0.0003 wt % and about 2.0 wt %; or between about 0.0003 wt % and about 1.0 wt %; or between about 0.0005 wt % and about 10 wt %; or between about 0.0005 wt % and about 5.0 wt %; or between about 0.0005 wt % and about 3.0 wt %; or between about 0.0005 wt % and about 2.0 wt %; or between about 0.0005 wt % and about 1.0 wt %; between about 0.001 wt % and about 10 wt %; or between about 0.001 wt % and about 5.0 wt %; or between about 0.001 wt % and about 3.0 wt %; or between about 0.001 wt % and about 2.0 wt %; or between about 0.001 wt % and about 1.0 wt %; between about 0.01 wt % and about 10 wt %; or between about 0.01 wt % and about 5.0 wt %; or between about 0.01 wt % and about 3.0 wt %; or between about 0.01 wt % and about 2.0 wt %; or between about 0.01 wt % and about 1.0 wt %; between about 0.1 wt % and about 10 wt %; or between about 0.1 wt % and about 5.0 wt %; or between about 0.1 wt % and about 3.0 wt %; or between about 0.1 wt % and about 2.0 wt %; or between about 0.1 wt % and about 1.0 wt % viscoelastic polymer.

The volume ratio of the solvated viscoelastic polymeric gel to purified water is between about 1:1 and about 1:5 depending on the molecular weight of the polymer in the solvated gel. For lower molecular weight polymers, such as HPMC, a ratio of about 1:2 works well. For higher molecular weight polymers, such as hyaluronan, it is best to emulsify the solvated polymeric gel at a higher dilution, in about 1:4 ratio. In various preferred embodiments the ratio is about 1:1, 9:10, 8:9, 7:8, 6:7, 5:6, 7:9, 3:4, 5:7, 7:10, 2:3, 5:8, 3:5, 4:7, 5:9, 1:2, 4:9, 3:7, 2:5, 3:8, 1:3, 3:10, 1:4, 2:9, 2:7, 1:5, and about 1:3000. In a further preferred embodiment, the ratio is between 9:10 and 1:4, more preferably between 1:2 and 1:3.

The purified water used in the present invention may have resistivity of between about 60 kΩ-cm to about 17.9 MΩ-cm. For example, resistivity of the purified water may be about 1 MΩ-cm, about 2 MΩ-cm, about 3 MΩ-cm, about 4 MΩ-cm, about 5 MΩ-cm, about 6 MΩ-cm, about 7 MΩ-cm, about 8 MΩ-cm, about 9 MΩ-cm, about 10 MΩ-cm, about 11 MΩ-cm, about 12 MΩ-cm, about 13 MΩ-cm, about 14 MΩ-cm, about 15 MΩ-cm, about 16 MΩ-cm, about 17 MΩ-cm, or about 18 MΩ-cm.

The volume of the resulting composition can be any volume suitable for a particular use. For delivery, the only limitation on the volume is to provide enough to create a continuous coating that is at least one molecular layer thick on a surface to be coated. Since the composition comprises macromolecules, the thickness is typically more than 1 nm. In a non-limiting embodiment, a droplet of about 0.5 μL or more of the composition on a lens is suitable to cover a 5 or 6 mm lens.

The preferred viscoelastic polymeric gel is solvated. As used herein, “solvated” means water molecules associate with a polymer chain by electrostatic dipole-dipole interactions between the water molecules and polymer components. Thus the polymer chains are surrounded by an essentially continuous molecular tube made of water molecules whose dipoles are aligned to form a solvation “cage” around the polymer chains to form gel “strands”. To analogize the viscoelastic polymeric gel with a strand of pearls, the polymer is the thread while the water molecules are the threaded pearls. Solvation of the viscoelastic polymer allows for the presence of ions in the gel, which can enhance conduction and electrostatic interaction along the polymer chains.

In preparing the solvated viscoelastic polymeric gel of the invention, the polymer chains are preferably initially well-hydrated; preferably, the polymer is at least 60%, 70%, 80%, 90%, or fully hydrated; or between 60-100%, 70-100%, 80-100%, or 90-100%. Solvation can be measured during preparation of the gel. For example, the polymer can be a powder measured by weight, and the solvent (e.g., water) can be measured by volume. The solvated viscoelastic polymeric gel may be prepared directly from dry powdered viscoelastic polymer by hydrating the dry polymer by addition of water (e.g, deionized or purified water).

a. Viscoelastic Polymer

Any physiologically compatible viscoelastic polymer capable of forming a solvated gel and otherwise meeting the requirements recited herein can be used in the present invention. In a preferred embodiment, the viscoelastic polymer is hydrophilic, which promotes solvation of the polymer and enhances conduction and electrostatic interaction along the polymer chains. As will be understood by those of skill in the art, and based on the teachings herein, the molecular structure, molecular weight, and concentration of the polymer can determine the characteristics of the resulting polymeric gel.

In certain embodiments, the viscoelastic polymers are polysaccharides. Non-limiting examples of polysaccharide polymers include arabinoxylans, cellulose, chitin, pectins, glycogen, and starches. For example, the cellulose polymers may be cellulose esters or cellulose ethers. Cellulose esters includes aliphatic carboxylic acid esters (such as cellulose acetate, cellulose triacetate, cellulose butyrate, and cellulose propionate), aromatic carboxylic acid esters (such as cellulose phthalate; inorganic acid esters such as cellulose nitrate, cellulose sulfate, and cellulose phosphate), mixed acid esters (such as cellulose acetate propionate, cellulose acetate butyrate, cellulose acetate phthalate, and cellulose nitrate acetate), and cellulose ester derivatives (such as polycaprolactone grafted cellulose acetate). Cellulose ethers include alkyl cellulose ethers (such as methyl cellulose, ethyl cellulose, ethyl methyl cellulose, and benzyl cellulose), hydroxyalkyl cellulose ethers (such as hydroxyethyl cellulose, hydroxypropyl cellulose (HPC), hydroxyethyl methyl cellulose, hydroxypropyl methyl cellulose (HPMC), and ethyl hydroxyethyl cellulose), and carboxyalkyl cellulose ethers (such as carboxymethyl cellulose (CMC)). Preferred cellulose polymers include HPMC, hydroxyethyl cellulose, methylcellulose, and HPC. Molecules similar to HPMC, such as having the basic monomer C₃₂H₆₀O₁₉, 748.8 grams/mole in the stoichiometry C₆H₇O₂(OH)ₓ(OCH₃)_{y}(OC₃H₇)_{z} (x+y+z=3), may also be a cellulose polymer.

Other non-limiting examples of polysaccharide polymers include lipopolysaccharides and glycosaminoglycans. For example, the viscoelastic polymer may be hyaluronan, which is the polymer forming the eye vitreous humor and can be extracted from animal tissue in various polymeric lengths, forms, purity and concentration. Similar molecules of the basic monomer C₃₃H₅₄N₂O₂₃, 846.8 grams/mol may also be a glycosaminoglycan. Other examples of glycosaminoglycan polymers are heparan sulfate, heparin, keratan sulfate, dermatan sulfate, and chondroitin sulfate.

In other embodiments, the viscoelastic polymers may be polyethylenes, polyvinyls, or polyacrylates. Use of these polymers may involve harsher solvents making them better suited for transparent surfaces that do not come into close contact with the eyes.

b. Proper Meshing of Chains in the Viscoelastic Polymer

As used herein, “proper meshing” means that the fully solvated polymer strands, when emulsified in the purified water, still mechanically and electrostatically interact with one another to form an open network of connected polymeric strands in the manner of a weft in an open weave fabric. New water molecules arising from condensation can freely flow through the holes of the open weave. However, the strands also provide a continuous and stable network where ionic conduction can occur while maintaining hydrophilic properties without any dilution effect from the accumulation of pure condensed water. This stable, hydrophilic open mesh of hydrated polymer strands helps maintain the elimination of condensation (fogging) for extended periods of times, such as during eye surgery where moisture distilled from the tissue can condense on a silicone IOLs. Separate preparation of the solvated viscoelastic polymeric gel from the composition of the present invention permits formation of a well-hydrated autonomous gel, because water molecules can easily surround the well-hydrated polymer chains. Thus separate preparation facilitates formation of a lightweight and open mesh. In another preferred embodiment, the viscoelastic polymer comprises short lateral side groups, which ensure proper meshing of the chains when the gel is mixed.

Three connecting side groups are typically sufficient for meshing of the chains. As used herein, “short side groups” means that the side arms of the monomer are shorter than the monomer itself. In HPMC, the hydroxypropyl side groups can mechanically interact by tangling with surrounding molecules. A completely linear polymer would not work as well to create an open mesh of fully solvated polymer strands. Hydroxy side chains of HPMC also favor solvation and hydrophilic properties making this polymer more cohesive and more likely to interact with nearby strands.

In a further preferred embodiment, the viscoelastic polymer comprises hydroxy side groups, which enhance solvation and decrease agglomeration as seen in sodium hyaluronate. Akin to human vitreous humor, hyaluronates are more cohesive and viscous. Hydroxy termination of the monomer enhances polarization and attraction with water molecules, which enhances solvation and electrostatic interaction leading to the desired hydrophilic properties in sodium hyaluronate. Simple monomer side chains, such as —CH₂—OH—CH₃ and hydroxy groups, are less likely to shield or interfere with solvation than more complex ones hydroxypropyl groups (—CH₂C(H)(OH)CH₃). HPMC is dominated by such simple monomer side chains, while the structure of hyaluronan is much less so, making it more difficult to fully solvate. Thus HPMC is a preferred embodiment compared to hyaluronates as the lower molecular weight chains of HPMC form less viscous polymer gels than those formed from hyaluronate. The ratio of H to C is 1.875 (60/32), and H to O is 3.15 (60/19) within the HPMC monomers is more favorable than the H/C ratio of 2.35 (54/32) and the H/O ratio of 2.35 (54/23) in hyaluronate monomers, because the former side groups are shorter (contain fewer atoms) and more likely to hydrate.

c. Viscosity of the Viscoelastic Polymeric Gel

As disclosed above, a wide spectrum of viscoelastic polymers can be used herein. At the one end of the spectrum are more fluidic polymers, such as HPMC, which are able to coat a surface. At the other end of the spectrum are more viscous polymers, such as hyaluronan. In a preferred embodiment, the viscosity of the solvated viscoelastic polymeric gel is between about 50 centipoise (cP) and about 5000 cP. In further preferred embodiments, the viscosity of the solvated viscoelastic polymeric gel is between about 50 cP and about 4500 cP; or about 50 cP and about 4000 cP; or about 100 cP and about 5000 cP; or about 100 cP and about 4000 cP; or about 100 cP and about 3000 cP; or about 200 cP and about 3000 cP; or about 100 cP and about 2000 cP; or about 200 cP and about 2000 cP; or about 100 cP and about 1500 cP; or about 200 cP and about 1500 cP; or about 100 cP and about 1000 cP; or about 100 cP and about 1000 cP; or about 500 cP to about 5,000 cP; or about 1,000 cP to about 4,000 cP.

In some embodiments, the viscosity of the solvated viscoelastic polymeric gel is modified by utilizing a viscoelastic polymer with a specific molecular weight. In one non-limiting example, a tenfold decrease in polymer molecular weight can result in a viscosity decrease of over 1000 times. For example, a 20,000 Da cellulosic gel could be diluted by only 8% in water by weight. A 20,000 Da polymer could have a viscosity as low as few hundreds centipoise; increasing the polymer concentration could provide an increase of viscosity by about two order of magnitude. Then, the viscosity could be in the tens of thousands of cP, for example, in the range of about 20,000 cP, and require appropriate dilution in the gel (e.g., with water or purified water) to achieve a preferred viscosity.

In a further preferred embodiment, HPMC of molecular weight 86,000 Da is used at 2% by weight in saline, resulting in solvated viscoelastic polymeric gel having a viscosity of about 4000 cP. In a further preferred embodiment, a 2.5% HPMC (86,000 Da) gel by weight in saline exhibits a viscosity of 15,000 cP. Although a higher viscosity than preferred for forming the composition, higher concentration gels have value, for example, by extending the time to condensation, when used in the antifogging coatings, devices, and methods of the invention (see below). In a further embodiment, 120,000 Da HPMC, a vitreous substitute, can be hydrated in a gel to a concentration of 2% by weight in saline, prior to mixture with purified water to yield a matching viscosity of about 15,000 cP.

In another preferred embodiment, the solvated viscoelastic polymer gel can be a coherent (i.e., does not break apart) and well-hydrated gel. Such preferred gels can yield a hydrophilic viscoelastic gel having sufficient viscosity (e.g. 4000 cP) to form an open hydrophilic molecular mesh of lower viscosity which can be used as the second layer component in the devices of the invention. In a further preferred embodiment, the solvated viscoelastic polymeric gel is prepared such that there are enough water molecules in the gel to create well-hydrated polymer chains with a “cage” of water dipoles surrounding the chain in an essentially complete first solvation radius. For example, well-hydrated polymeric chains can include about 20 to about 100 water molecules per monomer along the polymeric chain; preferably between 30 and about 100; or about 40 and about 100; or about 50 and about 100; or about 60 and about 100; or about 70 and about 100; or about 80 and about 100 water molecules per monomer along the polymeric chains. The number of water molecules per monomer can be derived from the monomer length and the first, second and third solvation radii.

In a further preferred embodiment, a solvated 2 wt % viscoelastic HPMC gel is prepared so that there are at least 80-100 molecules per monomer along the polymer chains. For 80,000 Da HPMC, a 2% gel in saline has about 200,000 water molecules for each polymeric chain. Such a polymeric chain has about one thousand monomers per chain, on average, corresponding to about 200 water molecules around each monomer. Such is sufficient to build a complete first solvation radius; the extra water molecules avoid any “bare”, unhydrated CH-based molecular terminations and initiate the second solvation radius. In other embodiments of this example, hydrating between 60-100%, 70-100%, 80-100%, or 90-100% of the CH-based molecular terminations are suitable. That is, main polymeric chain and its side groups have about the same hydration requirements.

d. Concentration of the Viscoelastic Polymer in Relation to the Viscoelastic Polymeric Gel

In one preferred embodiment, the solvated viscoelastic polymeric gel can have a polymer concentration between about 1% and about 10% by weight. In various preferred embodiments, the polymer concentration is between about 1% and about 9%; or about 1% and about 5%; or about 1% and about 7%; or about 1% and about 6%; or about 1% and about 5%; or about 1% and about 4%; or about 1% and about 3%; or about 1% and about 2%; or about 1.5% and about 10%; or about 5% and about 9%; or about 1.5% and about 8%; or about 1.5% and about 7%; or about 1.5% and about 6%; or about 1.5% and about 5%; or about 1.5% and about 4%; or about 1.5% and about 3%; or about 2% and about 10%; or about 2% and about 9%; or about 2% and about 8%; or about 2% and about 7%; or about 2% and about 6%; or about 2% and about 5%; or about 2% and about 4%; or about 2% and about 3%.

As will be understood by those of skill in the art, and based on the disclosure herein, the viscoelastic polymer concentration can be adapted to produce a solvated viscoelastic polymeric gel having the desired viscosity. The desired viscosity of the gel should be high enough to maintain the antifogging coating of the invention (see below) as a stable sheet on a surface (i.e., silicone) despite gravity and allow for formation of a homogeneous mixture without agglomeration.

### Antifogging Coatings

Another aspect of the invention is directed to process steps for the application of the emulsion to create semi-permanent or permanent antifogging coatings. The process steps described herein are parallel for each type of coatings. The process steps include the following methods for application of the emulsion during fabrication: immersion, immersion and controlled drawing, roller impression, spray application, shower/jet application, pouring application, brush application, shaped scraper application, film press application, compression assisted application, and combinations of these methods. In certain aspects, synthesis, fabrication and processing methods aim at generating a temporary, semi-permanent or permanent surface antifogging coating, that is wet or solid, that allows for fluid condensation without fogging, defined here as avoiding droplet nucleation that cannot be detected in the optical range whether for controlling fog of condensing surfaces; printing, painting or food storage/preservation processes; and/or nucleation of molecular sheets and two-dimensional fluid flow sheets, essentially laminar, on any material surfaces without the formation of droplets or three-dimensional features. An important feature of the synthesis, fabrication and processing methods is a physical coating that can be applied to any material surface without complicated chemical reactions or processes. Values of the coating process parameters may be adjusted to account for variation in the physical properties of the surfaces to be coated. Exemplary procedures are disclosed in detail in the Examples section that follows.

In one implementation, the invention is directed to methods for producing the antifogging coatings, for example the antifogging solid dry film, from the composition of the invention. In some embodiments, the antifogging solid dry film comprises a mixture of a solvated viscoelastic polymeric gel, comprising a viscoelastic polymer having a molecular weight of between about 20,000 Da and about 4,000,000 Da and purified water, wherein the volume ratio of the solvated viscoelastic gel to the purified water is between about 1:1 and about 1:5. In some implementations, the composition in the antifogging solid dry film has a conductivity of less than about 250 μS/m. In one preferred embodiment of the present invention, the antifogging solid dry film has a density between about 0.5 monomers/nm² and about 2000 monomers/nm²; or between about 0.5 monomers/nm² and about 1750 monomers/nm²; between about 1.0 monomers/nm² and about 1750 monomers/nm²; between about monomers/nm² and about 1750 monomers/nm²; between about 100 monomers/nm² and about 1750 monomers/nm². In another preferred embodiment, the antifogging coating has an areal density of between about 1018 atom/cm2 and about 1019 atom/cm2 as measured by He⁺⁺ Rutherford backscattering spectrometry (RBS).

Synthesis, fabrication and processing methods for producing the antifogging solid dry film may be adjusted to appropriate values for the extensively varied range of materials surfaces. In one embodiment for producing the antifogging solid dry film, the method may comprise forming a solvated viscoelastic polymeric gel; generating an emulsion comprising the solvated viscoelastic polymeric gel and water; applying the emulsion to a surface; and drying the emulsion on the surface to produce the antifogging solid dry film. In the preferred embodiments, the solvated viscoelastic polymeric gel should comprise the same properties as the viscoelastic polymeric gel described for the composition of the invention. Similarly, the volume ratio of the gel to the water should also comprise the properties as the disclosed for the composition of the invention. Most preferably, the volume ratio of the gel to the water should be between about 1:2 and about 1:3. Purified water is also preferably used to generate the emulsion, wherein the conductivity of the emulsion is less than about 250 μS/m. In some preferred embodiments, the purified water should have resistivity of about 2 MΩ-cm. In some embodiments, the temperature for drying the emulsion on a surface is from about 0° C. to 48° C., e.g. any range within 0° C. to 48° C. such as 0° C. to 5° C., 0° C. to 10° C., 5° C. to 10° C., 10° C. to 15° C., 0° C. to 15° C., 0° C. to 20° C., 5° C. to 20° C., 10° C. to 20° C., 10° C. to 30° C., 15° C. to 30° C., 15° C. to 35° C., 20° C. to 40° C., 20° C. to 48° C., 25° C. to 48° C., 30° C. to 48° C., etc.

For some embodiments, the step of applying the emulsion to a surface and drying the emulsion on the surface may be repeated to produce multiple coats of the emulsion on the surface. In other embodiments, the step of applying the emulsion to a surface is repeated to coat the emulsion in single, successive layers on the surface, similar to a varnish or a lacquering process, before drying the emulsion to achieve a solid film. For applying the emulsion to the surface, the step may comprise immersing the surface in the emulsion; impressing the emulsion onto the surface with a roller; spraying the emulsion onto the surface; showering or jetting the emulsion onto the surface; pouring the emulsion onto the surface; or brushing the emulsion onto the surface. In a preferred embodiment, applying the emulsion to the surface comprises immersing the surface in the emulsion and drawing the surface out of the emulsion at a rate of between about 1 mm/s and about 1 m/s, for example at a rate of between about 1 mm/s and about 1 cm/s, about 5 mm/s and about 1 cm/s, about 1 cm/s and about 5 cm/s, about 1 cm/s and about 7.5 cm/s, about 1 cm/s and about 10 cm/s, about 1 cm/s and about 50 cm/s, or about 1 cm/s and about 1 m/s.

The antifogging solid dry film may also be created directly on a surface that requires the anti-fog technology, or the antifogging solid dry film may be created on a separate surface and then applied to the surface requiring the anti-fog technology using a binding agent. The binding agent may be, for example, the emulsion comprising the composition of the present invention (such as the emulsion that created the antifogging solid dry film), any optically satisfactory gluing agent, or water. In some embodiments, the emulsion improves visualization by eliminating spherical aberration. This is achieved because the while the emulsion is flowing on the surface, it forces its drying surface, and the antifogging solid dry film when the emulsion is used as a binding agent, to remain parallel with the surface thereby forcing all light rays to enter at the same angle without further scattering or distortion as though the light rays were just entering through the surface.

In certain embodiments, the antifogging coatings of the present invention, whether as an emulsion or as an antifogging solid dry film, form a continuous planar coating and can comprise either a bilayer consisting of two sheets or a single layer of the composition of the invention. For example, the antifogging coating comprises or consists of an optional first layer comprising or consisting of purified water and a second layer comprising or consisting of the composition of the invention, wherein, when the first layer is present, the first layer and the second layer are in direct contact. The layer(s) of the antifogging coating are compatible with a continuous flow of distilled water vapor in unlimited amounts, because they control fogging due to condensation as demonstrated herein.

In some preferred embodiments, the present invention provides methods for coating a hydrophobic surface, comprising coating the hydrophobic surface, wherein either the first layer of the antifogging coating, when present, is in direct contact with the hydrophobic surface, or the second layer of the antifogging coating is in direct contact with the hydrophobic surface. The hydrophobic surface can be of suitable type, including but not limited to silicone, hydrophobic acrylic, any form of silicon dioxide, quartz or silicon substrates used for medical device implants and surgical supplies, shunts, and tubing; and eyewear, such as sports visors, eye glasses, and goggles, having, for example high impact resistance coating such as a silicate over an underlying polycarbonate substrate. In one preferred embodiment, the antifogging coating is disposed on a hydrophobic surface, wherein the first layer and second layers comprise a combined single continuous layer that is in direct contact with the hydrophobic surface (i.e., the second layer, as described herein, is in direct contact with the hydrophobic surface). The antifogging coating disposed on a hydrophobic surface has exceptional clarity as shown by minimum optical distortion and excellent transparency.

The adhesion of the first and/or second layers to the surface is ensured by the water component of the emulsion. Cohesion of the applied layer sets a minimum amount of water in the emulsion and the hydration requirement of the polymer. If an emulsion is not used and a pure gel is applied, it can delaminate from the surface. During application, both the first and second layers may be merged as a single layer in direct contact with the surface since the matrix component of the emulsion is water. For example, a properly hydrated polymer in a properly prepared solution, can wet the surface uniformly, avoiding direct contact of the gel with the surface, and maintaining a flowing free water layer between the surface and the emulsion while the hydrated polymeric chain are found in the water matrix of the applied emulsion.

In a preferred embodiment, thorough rinsing, purity of the purified water and the tools used to deliver it, and uniformity of the purified water, easily achieved in a sterile environment, are employed to ensure uniformity of the layer(s). The unique approach to build the second layer, or the combined single layer, is to combine the electrolytic conduction of purified water with a surgically compatible, optically transparent medium with radically different molecular structure, into a uniform emulsion that is not only a gel nor only an aqueous solution.

In one preferred embodiment, the antifogging coatings of the present invention are designed to adapt to the unique electronic properties and concomitant adhesive response of silicone. Silicone is a composite material made of two molecular components, and consequently exhibits two different, parallel, antagonistic electronic and adhesive properties and responses upon exposure to water molecules. The dual response of silicone initially causes water vapor to condense in droplets rather than wet the surface in a uniform transparent layer. The strong hydrophilic adhesion of these droplets on an initially hydrophobic silicone makes the IOLs opaque.

In a preferred embodiment, the key ratio for the emulsion is 1:3 (gel:purified water) for optimal application. In use, the first and second layers can be disposed on a hydrophobic substrate as continuous films. In a preferred embodiment, the minimum thickness of the first and second layers, or a combined single layer, is each at least 3 to 4 times the roughness of the hydrophobic surface to be coated. If the layer is too thick, it can create a droplet with optical distortion and risk of delamination (dripping down) and loss of the film from the surface. Thus, in one non-limiting embodiment, for a smooth hydrophobic surface with a roughness of 10 nm, the minimum thickness of the first, second, or combined single layers each would be at least about 30 to 40 nm; for hydrophobic surface with a roughness of 100 nm, about 300 to 400 nm. In further preferred embodiments, the thickness of each layer is between about 30 nm and about 2 mm; or about 50 nm and about 1 mm; or about 75 nm and about 750 μm; or about 100 nm and about 500 μm; or about 250 nm and about 400 μm; or about 500 nm and about 500 μm; or about 1 μm and about 500 μm; or about 1 μm and about 400 μm; or about 10 μm and about 400 μm; or about 100 μm and about 500 μm; or about 100 μm and about 400 μm; or about 200 μm and about 500 μm; or about 200 μm and about 400 μm.

In various preferred embodiments, the volume of each layer can be any suitable for a given use. Similarly, any ratio of volumes of the different layers can be used as suitable for a given purpose; in one preferred embodiment, identical volumes are used. In another preferred embodiment, the volume of the aqueous layer does not result in a thicker layer than the emulsion.

For delivery, the only limitation on the volume of the second layer and/or combined single layer is to provide enough to create a film that is at least one molecule thick (more than a 1 nm, based on the polymer in the composition). Typically, a droplet of about 0.5 μL to about 1.0 μL for both layers on a lens will be a minimum to cover a 5 mm or 6 mm lens. In various preferred embodiments, the volume of the second layer ranges between 0.5 mL and 100 mL, depending on the area to be covered.

In one preferred embodiment, the second layer and/or combined single layer has a volume of about 0.5 μL to about 1.0 or more. Below such volumes, viscosity may limit the ability to control the composition ratio. In one embodiment, combining 0.5 mL of the viscoelastic polymeric gel with 0.5 mL of the purified water (1:1) yields an emulsion volume of 1 mL for mixing and delivery of the second layer and/or combined single layer on the lens. In a further embodiment, an emulsion of 10 mL is used for preparation in the operating room with using 0.5 mL to 1 mL for delivery of the lens via syringe.

Processing of a hydrophobic surface with the present invention may occur at any suitable time; the antifogging solid dry film may be produced on a lens prior to implantation, months in advance, and rehydrated in saline. As necessary, the antifogging solid dry film can be produced post implantation on any hydrophobic lenses. In another preferred embodiment, the antifogging solid dry film is produced just before surgery/implantation. When a first layer of antifogging solid dry film is produced on a surface, a second layer of antifogging solid dry film can be produced over the first layer at any suitable time after application of the first layer; preferably within 1 second to 5 minutes; even more preferably within about 5 seconds to about 60 seconds; or about 5 seconds to about 30 seconds; or about 5 seconds to about 10 seconds. For IOL implantation, the method may be used when an artificial lens is piggy-backed with a remaining natural lens.

The antifogging solid dry film can be applied prior to surgery (such as IOL surgery or implantation of hydrophobic medical devices), or in subsequent surgeries if, for example, a chronic eye condition, such as a detached retina, occurs. In one preferred embodiment, an emulsion is prepared, just prior to application, with a dispersive viscoelastic. The mixing is preferably conducted in glass vessels. The first layer can be optionally applied first to the hydrophobic surface, followed by layering of the composition in emulsion form. Each layer applied to the surface is a continuous layer, as noted above. The antifogging coatings can prevent and eliminate the almost instantaneous condensation of moisture (“fogging”) from live tissues during, for example, vitreo-retineal eye surgery when a silicone IOL is placed or already in place in the human eye. The maintenance of a pure hydrophilic character to the surface of the silicone implanted lens maintains the optical clarity critical for the surgeon to conduct the surgery and adjust the vision of the patient to its full potential, instead of being blinded by uncontrolled fogging.

In one preferred embodiment, the antifogging coating is placed on the posterior side of the lens. The weight of the antifogging coating is small in comparison to the electrostatic interaction with the hydrophobic surface to maintain a uniform molecular film and avoid delamination, deformation and/or detachment by gravity. The layer(s) can be applied by syringe dispensing or the Langmuir-Blodgett method onto the hydrophobic surfaces.

### Devices Comprising the Antifogging Coating

One aspect of the invention is directed to devices comprising the antifogging coating, wherein the antifogging coating, such as the antifogging solid dry film, is applied on a surface. The surface may be the windshield or mirror of an automobile, motorcycle, boat, airplane or a train. The antifogging solid dry film may also be on the transparent portion of goggles, camera lenses, corrective lenses, facial masks, facial shields, helmets, visors, endoscopes, laparoscopes, arthroscopes, or IOLs. The surface may also be that of a bottle or package.

In some embodiments, the devices of the invention have a surface that is hydrophobic. The hydrophobic surface may be any on which the device of the invention can be usefully applied as a coating, including but not limited to silicone, hydrophobic acrylic, any form of silicon dioxide, quartz or silicon substrates used for medical device implants; surgical supplies, shunts, and tubing; and eyewear, such as sports visors, eye glasses, and goggles. The surface may have, for example, high impact resistance coating such as a silicate over an underlying polycarbonate substrate.

In certain embodiments of the invention, the devices (such as bottles or packages) further comprise a solid film coating. Such devices are created by inserting the emulsion of the invention between the solid film to be bound and the surface of the devices, bottles, or packages. The emulsion can be applied on the surface, on the solid film coating, or on both to form a permanent film after drying. The solid film coating may be, for example, a layer of a transparent film. The transparent film may comprise a hydrophilic solid thin film material such as cellophane, cellulose acetate, poly(methyl methacrylate), polycarbonate, polyethylene, polyethylene terephthalate, polylactic acid, polyvinyl butyral, or combinations thereof. When such hydrophilic solid thin film is attached with the emulsion as the glue to a surface, the resulting dried antifogging solid dry film/hydrophilic solid film sandwich will act just as a single layer antifogging solid dry film with additional properties brought by the attached solid film, including increased resistance to abrasion, rubbing, scrubbing, and mechanical damage. In a preferred embodiment, the emulsion is used to attach a permanent solid thin film of food-grade or hydrophilic cellophane or any hydrophilic coating on any surface and to create a permanent, mechanically sturdy, well adhering combination of the permanent coating on that surface that anchors any other solid film, preferably a transparent solid film, of any composition on that surface.

In certain aspects, ink or paint is applied to the antifogging coating on a device of the invention, such as the bottle or package. Thus a surface coated with the composition of the invention is imprinted with one or more types of inks or paint. The surfaces to be painted or printed upon can simply be immersed in a bath containing the emulsion. An objective of treating surfaces with the disclosed antifogging coatings comprising the compositions of the present invention in the application of printing and painting is that the antifogging coating allows adhesion of ink on the surface due to its hydrophilic properties. Current technology involves processes such as etching prior to printing, which can be expensive and time consuming. One purpose of printing directly on bottles and packages is not only for better aesthetics but also to facilitate recycling and reuse of the bottles and packages. For example, to reuse such a bottle or package may only require washing of the bottle or package, thus eliminating the process of relabeling the bottle or package.

The ink may be a lithography or offset ink, a flexographic ink, an energy-curable ink (e.g., ultraviolet (UV) ink, electron beam (EB) ink), a gravure ink, a letterpress ink, or a specialty ink (e.g., screen ink, ink jet ink, thermochromic ink, photochromic ink, metallic ink, magnetic ink, electronic ink, intaglio, etc.).

Generally speaking, lithography or offset inks are oil-based paste inks, which are highly viscous and use varnish systems consisting of resins that dry either by oxidation or heat evaporation. Pigment concentration is relatively high, as the ink is applied in a very thin film of approximately 3 μm. The ink used in some embodiments of the devices of the invention must have some compatibility with water, because water is used to keep the non-image areas of the plate clean.

There are a number of offset variations. Web offset printing is done at speeds of up to 3,000 feet per minute. In order to accommodate the higher speeds, the inks must have lower viscosity and tack, while maintaining a high resistance to water. Heatset inks dry through heat, running through ovens on the press. Non-heatset inks dry by penetration, with the oils being absorbed into the non-coated substrate. Sheetfed offset inks dry via oxidation. Since oxidation causes the resins to crosslink, they have better resistance properties than many other types of offset inks. Direct lithography, used in areas such as business forms, does not use the offset blanket, instead transferring the image to the substrate. Coldset inks are solid at room temperature, with melting points ranging from 150° F. to 200° F. They are melted and impressed on cold paper, when they revert back to their solid state. News inks consist of pigment dispersed in mineral or soya oil, rather than more expensive vehicles. The oil is absorbed into the substrate, rather than dried by heat. Metal deco inks are used on beverage cans; these are cured by high temperature, which requires synthetic resin varnishes. They are highly pigmented and very viscous.

Flexographic inks (aka flexo) are liquid inks, utilizing solvent or water. In flexography, ink is dispensed by anilox cells onto a plate, and then transferred to the substrate. Water-based flexo is mainly used on kraft, corrugated, lightweight news-type paper or polyolefin film, while solvent-based inks are used on films and some paper surfaces.

Energy-curing ink technology is growing and is primarily found in flexo, though there is growth in offset. The inks consist of monomers and oligomers and are fluid, but are more viscous than flexo inks. They offer excellent gloss and resistance properties. There are two types of energy-curable inks UV inks incorporate photoinitiators, and use UV lamps for curing. UV inks are used in a number of processes, including packaging, screen printing, and compact discs. EB inks are cured by electrons. They are found in flexible packaging and folding cartons, particularly in food packaging, where the minimal odors and extractables are advantageous.

Gravure inks are low viscosity liquid inks, and engraved cylinders impart the ink onto the substrate. Gravure inks are mainly solvent-based, drying through evaporation. Gravure inks are found in longer-run applications.

Letterpress inks are viscous, and exhibit high tack. They are oil-based, and use resins that oxidize.

Many types of specialty inks are gaining in usage. Screen inks are a growing niche market with various end-use applications, from billboard advertising to labeling. Ink jet inks are a direct-to-substrate technology, consisting primarily of either pigment-based or dye-based systems that are channeled through a printer head. Thermochromic ink (heat-sensitive) and photochromic inks (light-sensitive) will change color when exposed to heat or light. These are particularly useful for packaging or for sensitive documents. Metallic inks, incorporating aluminum, bronze or copper flakes, are primarily found in packaging applications, where catching the customer's eye is critical. Magnetic and electronic inks react to impulses and form new images. Intaglio is used for currency and stamps, with the inks being compressed into the substrate. Currency inks are very viscous and highly pigmented.

### Fog-Free Surface

Still another aspect of the invention is directed to a method of generating a permanently fog-free surface via treating a surface and optionally followed a second treatment with molecular hydrophilic termination. This process removes rather than adds material on the surface to create a hydrophilic nano-topography. Depending on the material, it is preferably combined with a second, which adds to the created nano-topography the molecular adsorption as in the previous embodiments described above for a semi-permanent film to create a hydrophilic termination as a molecular termination of the nano-textured surface. The nano-texture renders the molecular adsorbate much more permanent than in the previous embodiment by increasing the magnitude of interaction forces between the nano-textured surface and the molecular adsorbate, making it orders of magnitude more lasting. The embodiment of a fog-free surface can be realized in the following fashion in one and/or preferably two stages.

In the first stage, the nano-topography of the dry permanent antifogging technology (i.e. the emulsion and the antifogging solid dry film) is created by removing surface molecules rather than adding a film, in a similar, random or semi-periodic nano-pattern. This may be accomplished by removal and/or imprinting of surface material to create a hydrophilic nano-topography with horizontal maximum size feature less than about 0.2 μm (or about 200 nm) and vertical maximum size feature of several tens of nm, or an average roughness r.m.s (root mean square) less than about 0.2 to about 0.4 nm. In certain embodiments, the horizontal maximum size feature is less than about 50 nm, less than about 100 nm, less than about 150 nm, less than about 200 nm, less than about 250 nm, less than about 300 nm, less than about 350 nm, less than about 400 nm, less than about 450 nm, or less than about 500 nm. In other embodiments, the average roughness root mean square is less than about 0.01 nm, less than about 0.05 nm, less than about 0.1 nm, less than about 0.1 nm, less than about 0.2 nm, less than about 0.3 nm, less than about 0.4 nm, less than about 0.5 nm, less than about 0.6 nm, less than about 0.7 nm, less than about 0.8 nm, less than about 0.9 nm, or less than about 1.0 nm.

For preferred embodiments, the nano-topography is created without using nano-photolithography, masking, or/and periodic patterning, which are cost prohibitive. Instead, the nano-topography is created using a well-controlled molecular-layer-by-layer etching to create a random pattern of molecule-size troughs and crests at the nano-scale, which is referred to herein as “molecular nano-etching.” Molecular nano-etching can be accomplished via liquid phase nano-etching by immersion of the surface, or vapor phase nano-etching, or gas-phase nano-etching. Molecular Nano-etching is preferred because it eliminates stiction in the liquid phase.

In further embodiments, surface nano-etching for silica-based materials (including, SiO₂, plain glass, quartz, boro-silicates, soda glass, commercial glass used for window panes for housing, cars, appliances, pyrex, optical glass, etc.) may be accomplished using a well-controlled, slow hydrofluoric acid (HF)-based etch which removes SiO₂ molecules without pitting or anisotropic etching by controlling well the surface isotropy of the etch rate to creating nano-corrugations or roughness at the molecular scale instead of scales above 200 nm in the horizontal feature of the etch (i.e., along the surface dimensions) while maintaining average vertical roughness above the surface below 0.2-0.4 nm in root mean square (r.m.s) roughness.

Etching agents that may be used with the methods of the present invention include HF, buffered HF (bHF), nitric acid (HNO₃), hydrogen peroxide (H₂O₂), phosphoric acid (H₃PO₄), buffered oxide etch (BOE), potassium hydroxide (KOH), ethylenediamine pyrocatechol (EDP), tetramethylammonium hydroxide (TMAH), aqua regia, sulfuric acid (H₂SO₄), iodine and potassium iodide solution, hydrochloric acid (HCl), citric acid, acetic acid, or any combination of these agents. In preferred embodiments, the etching agent is HF. in some embodiment, HF solutions is used for direct immersion in the liquid phase. In other embodiment, HF solution is used for vapor etching in a closed atmosphere. While both embodiments are slow, controlled vapor etching using HF solutions renders better performance for hydrophilicity and anti-fog. Vapor etching also produces the most uniform and even nano-roughness to cause hydrophilicity and water condensing in 2-dimensional sheets.

In certain aspects, the disclosed methods avoid stiction to favor nano-etching. For example, vapor etch avoids “stiction,” which is the adhesion of particulates by electrostatic attraction, which are very difficult to remove except by mechanical abrasion. Eliminating stiction greatly reduces the scale of the surface topography to below the desired dimensions.

In this embodiment of the invention, the nano-topography mimics the nano-topography of the antifogging solid dry film or cellulose or polyethylene glycol film by etching or imprinting the surfaces instead of merely putting a film on it. While other methods, such as periodic and/or aperiodic photolithographic patterning and texturing at the nano-scale and various other complex methods can also render surfaces hydrophilic and anti-fog, the processing duration, the numerous processing steps (of which they are many more than two, up to 20), subsequent costs and complexity, including the need for nano-scale masks, photoresists, and nano-photolithography apparatus render these approaches less desirable. These considerations make nano-photolithography and other similar costly and lengthy processes cost-prohibitive for applications other than very high return devices such as microelectronics or photonics. In contrast, the present invention provides an innovative feature involving the use of much less complex and less costly molecular nano-etching to create anti-fog surfaces in the same way and to build a hydrophilic nano-topography. The present method advantageously has greater simplicity, lower cost and ease of deployment when compared to mechanically imprinting at the nano-scale and nano-photolithography. It addresses also potential defects via a single additional step—the second step of adding a molecular adsorbate to prevent incubation.

The nano-etching method for generating a permanently fog-free surface provides a simple two-pronged approach to render a surface anti-fog. It is possible to use only the first step of molecular nano-etching in a very well controlled process when contamination and particulates can be continuously eliminated. The second step of molecular adsorption is a preventative step to avoid potential incubation when a less well controlled nano-etching process is used for cheaper production or because of potential contamination of the solutions for etching or generating the vapor can occur. It makes the process more foolproof and less sensitive to surface contamination later on, making the anti-fog surface also more robust.

Another advantage of the nano-etching method for generating a permanently fog-free surface versus is that hydrophilicity and anti-fog properties do not require periodicity in the nano-topography of a surface. The only features it requires are nano-topographical features whose dimensions are below about 0.2 μm (or about 200 nm) to limit droplet size to below the visible range, to avoid refraction and detection in the visible range. Thus a statistically, random distribution of nano-features is suitable.

In stage two, after molecular nano-etching, the nano-textured surface can still retain a so-called optical “incubation period” during condensation. “Incubation” of the two-dimensional transparent water film is a time delay in the formation of the continuous 2-dimensional film. It can be briefly observed optically as a temporary semi-opaque film of greatly reduced density but still optically detectable refracting microdroplets prior to the condensing water coalescing to form a thin continuous film that is optically transparent without an air/water interface. Incubation is due to nano-etching either limited in duration or not controlled well enough to avoid too large size topography.

The second stage is thus the molecular adsorption of species with hydrophilic radicals on the surface now etched in the desired pattern at the nano-scale to eliminate incubation and force the adsorbing water molecules to interact with the surface instead of with each other and to form a continuous film without any optically detectable trapped air between micro-droplets. The hydrophilic nano-topography traps the molecular adsorbate in a much more permanent way than a conventional surface. The molecular adsorbate can be any hydrophilic polymer or emulsion comprising the composition of the present invention, such as an emulsion with HPMC and/or an emulsion with polyethyelene oxide, or any emulsion made with these or other hydrophilic polymer disclosed herein. They can be dried and remain on the surface without affecting transparency.

### EXAMPLES

The present invention is further illustrated by the following examples that should not be construed as limiting.

### Example 1

### Gel Selection and Formation

Any long chain hydrophilic polymer can be used, provided it easily forms a gel and has a molecular length ranging preferably between at least 100 radicals and 10,000. Below the range of 100 radicals, polymeric strands become too short to effectively mesh into a mesh structure, and above the range of 10,000 the strands become too heavy and form too viscous of a gel to be used effectively. Viscoelastic gels are preferred because they tend to remain continuous when under tension from volume change during drying instead of forming cracks. A preferred embodiment for making the emulsion for a permanent antifogging coating follows:

1) Polymer Selection and Gel Formation

A preferred polymer of choice is one of the lighter molecular weight long chain polysaccharides such as food grade hydroxypropyl methylcellulose (HPMC), also known as hypromellose, particulate free, and of high purity (the grade of HPMC can be checked optically, via its clear white color). Using a 70,000 Da-100,000 Da HPMC (about a thousand radical per strand) is a preferred embodiment to balance viscosity with fluidity for this application. The lightness of the polymer gel HPMC forms enables a better coating uniformity on materials, as delamination from gravity during drying is less of an issue.

There are many methods to create a well-hydrated gel where most of the water molecules added to the powder is not free flowing but forming molecular tubes of sheaths around each polymer strands, with the number of layers water molecules forming the thickness of the sheath being around 3 layers.

The goal is the formation of these water molecules tubules around the strands that create the viscosity property of the gel. Two parts of dry HPMC polymer powder by weight combined with 98 parts of water with a range of 1-4 part of HMPC is optimum. Such gel exhibits a viscosity of about 4000 cP at 25° C.

At the other end of the spectrum, if another hydrophilic polymer is used, for example, a polypeptide or polysaccharide with 10 times longer polymer strands that are thus heavier in weight such as sodium hyaluronate of hyaluronan, more water molecules are required to create a gel. In this case a lower concentration of dried polymer powder, 1 to 1.2 parts to 98.8 parts of water is the preferred embodiment, but the longer polymer strands yield a viscosity that is 20 times higher (about 100,000 cP at 25° C.).

In all cases, the hydrated gel is too viscous and too concentrated to yield an applicable emulsion with good coating properties. The hydrophilic properties can even be lost upon drying due to the excessive density of polymer strands in the structure.

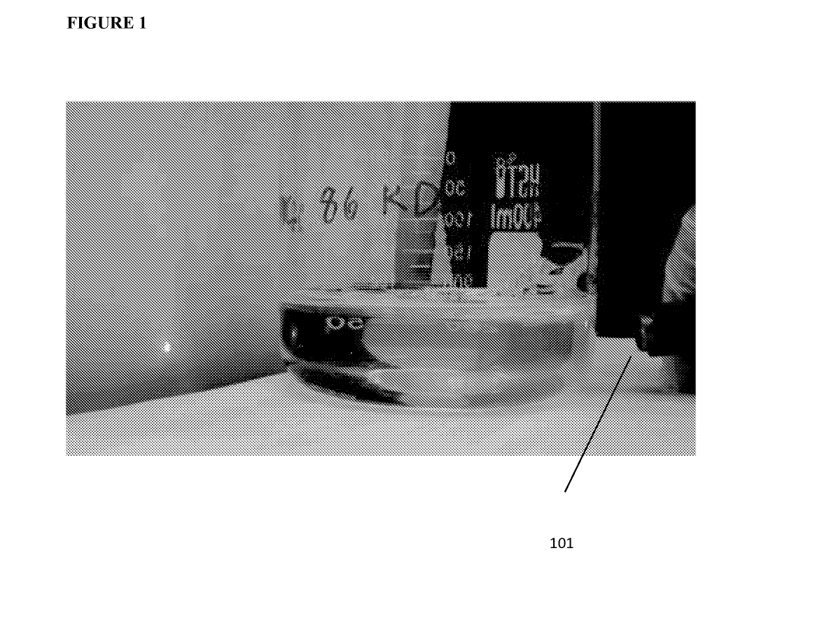

A key check on the quality of the gel is to use the Tyndall effect (see FIG. 1). Significant light scattering, most easily observed from a coherent laser beam (101) occurs in the clear gel, which is observed as free flowing water molecules are kept to a minimum, and the medium the light interacts with is not an amorphous liquid, but at least mostly organized water dipoles in tubules. The light beam will show significant divergence from scattering in the medium, doubling its diameter about every inch or 2 in the gel, and showing visible scattering in its path.

2) Water Specification for Gel Formation

One key element for the permanent antifogging coating of the present invention is the use of 2 MΩ(equivalent to 50 μS/m) deionized or distilled water to hydrate the hydrophilic powder to make an optically clear gel with the most significant stability in the polymer solvated state.

In other words, the presence of other solutes will affect the optical clarity. The purity thus must be at least in the parts per million (ppm) range. All vessels and processing containers have to be washed with soap, preferably SCI solution (H₂O₂:NHOH₃:H₂O, 1:1:4 or 1:1:5), and rinsed in deionized water for sterilization, disinfection and purity, which guarantees both long shelf life and optical quality.

3) Conditions for Creation of the Gel

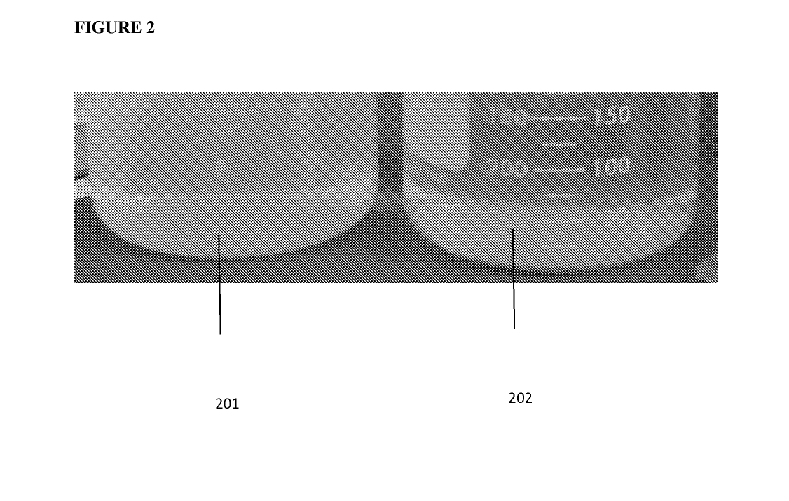

The preferred method for creating the gel is a hot-cold method where the desired number of mL of 2 MΩ distilled water is contained in a Pyrex beaker and heated at about 48° C. over a hot plate.
1. A matching amount of high purity 80,000 Da HPMC, is slowly added to the water.
2. The mixture is then stirred continuously until all the HPMC particles are completely dissolved.
3. The solution is then stored in a refrigerator.
4. The cold temperature of the refrigerator (5° C.) actually increases the uniformity of this particular gel as the heat initially enhanced HPMC diffusion but cooling increases solubility of the dissolved HPMC and thus the formation of the water tubules around each strand.
5. The refrigerated solution shows better optical clarity and speeds up gel formation as opposed to room temperature gelation which also produces a gel but takes more time (see FIG. 2). The sample on the left (201) was left to cool at room temperature after dissolution of as hydroxypropylmethylcellulose (HMPC) at 48° C. while the sample on the right (202) was cooled in the refrigerator at 5° C. Cooling increases the speed of solvation and gelling of HPMC in distilled water. The gel becomes clearer much more quickly, and will eventually reach the clarity of the gel shown in FIG. 1.

### Example 2

### Emulsion to Form Permanent Antifogging Coating

An emulsion used to form the permanent antifogging coating was produced by following the following steps:
1. A specific amount of 2 MΩ distilled water has to be mixed with the gel prepared as outlined in Example 1 to create an “emulsion.” The composition's formulation is how to create the permanent antifogging coating.
2. A dilution of 5:1 or above is generally too high and inadequate to create an anti-fog dry film, for a permanent solution, while it works fine to apply thin, temporary, wet films on medical and surgical lenses facing down or forward. Dilutions of H₂O:gel (n:1) where n is greater than or equal to 1 are optimum for in vivo, wet medical applications on IOLs and endoscopes, which all use wet coatings but not for dry coatings.
3. The thinner, more fluid temporary, emulsion works fine as a wet anti-fog coating but cannot form a permanent, immediately anti-fog dry coating.
4. The proper dilution for the emulsion to form dry films that are optically clear and instantaneously anti-fog generally falls between 3:1 and 2:1.
5. This dilution of water to gel ensures that when the emulsion dries, it preserves a surface topography that mimics the wet film's effectiveness at controlling the water droplets so that it “wets” instead of “fogs.”
6. The absence of any salt or solute in this new emulsion ensures that HPMC does not fall out of solution during the drying process.
7. The Tyndall effect vanishes after the gel has been properly emulsified in water. This demonstrates that free flowing water molecules are present as a non-light scattering media between the solvated polymer strands and that the required geometric spacing between the strands to achieve the anti-fog effect has been created.
8. Detection of Tyndall scattering is found to occur for poor mixing or dilution below 2:1 and results in a too viscous emulsion for application, since not enough free flowing water molecules are present in that case.
9. Hence, Tyndall scattering can be used to monitor proper mixing and dilution of the emulsion besides checking for quality of initial gel.

### Example 3

### Application of the Emulsion to a Surface

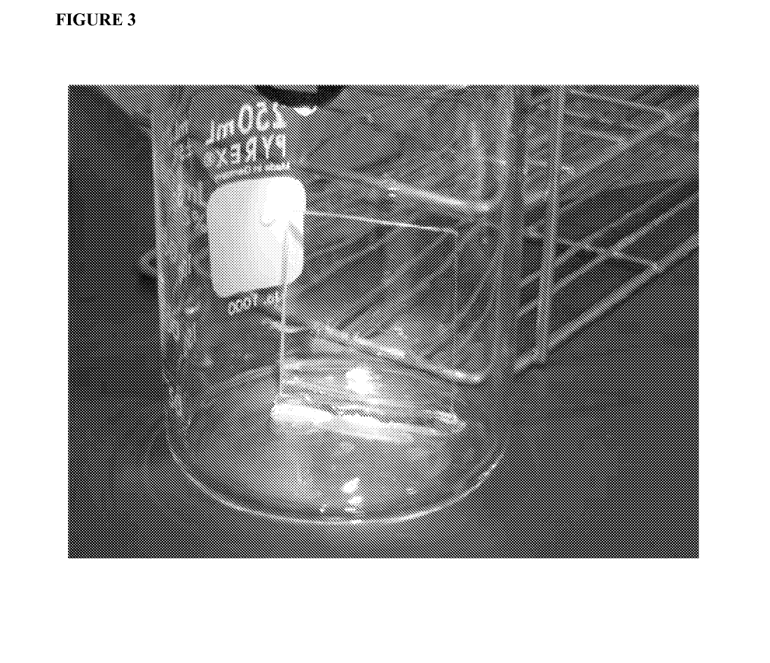

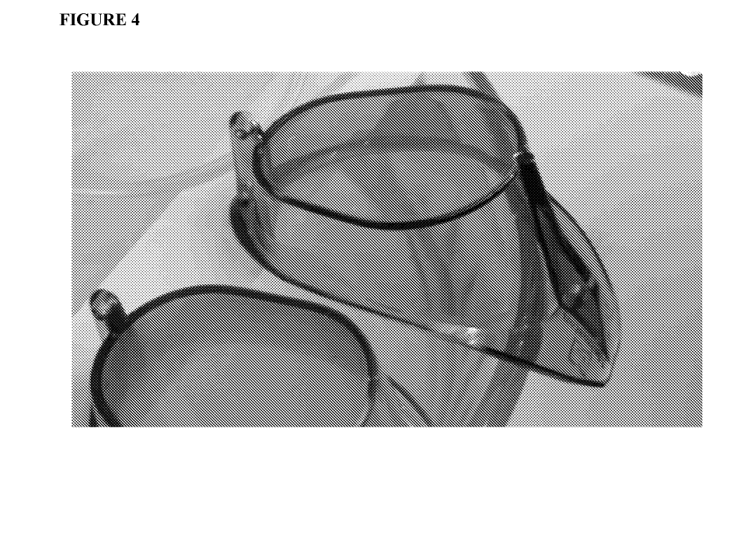

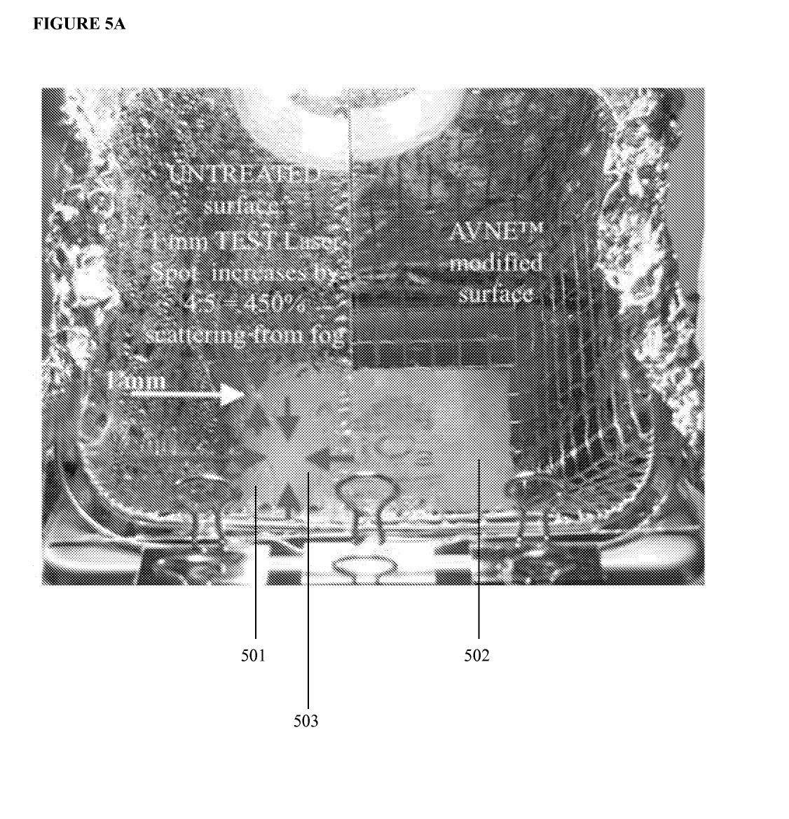

The emulsion formed in Example 2 can be applied to a surface by the following steps:
1. The emulsion for a permanent antifogging coating can be wiped on a surface to produce a thin film using a lint-free cloth.
2. It can be applied by dipping the surfaces to be coated in the emulsion and letting it dry.
3. The dipping process can be repeated twice or three times, or more, for non-planar surface, to let them dry with different orientations, such as concave side face down and then concave side face up.
4. Planar surfaces coat evenly, especially goggles and masks, which contain easily the emulsion as in a cup. See FIG. 4 for an example of goggles treated with an embodiment of the present invention. In FIG. 4, the bottom uncoated goggle lens (401) visibly shows condensation while the top coated goggle lens (402) does not.
5. A preferred embodiment is to let the surfaces dry horizontally, with airflow drawing humidity above the surface in a raised surrounding wall configuration to minimize perturbation on the surface.
6. Surfaces can also be dried in an immersion mode where the surface (301) emerges from the emulsion (see FIG. 3).
7. Drying can be completed in a few hours using fan flow, rotating drums, but should preferrably be completed in an atmosphere as cool as possible.
8. One preferred embodiment for drying conditions are in a fridge, at 5° C.-10° C. to maintain optical clarity.

### Example 4

### Characterization and Measurements with Prototypes

The following properties can be analyzed to determine the quality of the permanent antifogging coating produced with the present invention:
1. Tyndall Effect—various light colors are used (blue, red, green) and a laser. Various colors are used because shorter wavelengths tend to scatter more. The Tyndall Effect allows observation of light scattering behavior, which is indicative of the homogeneity of the gel.
2. Viscosity measurement—This is also another method of checking for quality and consistency of the product. A Brookfield viscosity-meter can be used.
3. Particle Induced X-Ray Emission to check purity and presence of contaminants.
4. Nuclear Resonance Analysis for mass spectrometry and atom counting.
5. Initial distilled water quality—the dry residue has to be optically undetectable, thus requiring dry residue in the ppm range and conductivity preferably at 2 MΩ-cm or 50 μS/m or better. All vessels and tools in contact with the gel and the final emulsion have to be cleaned with the same water quality.
6. The optical quality of the HPMC as white (using a standard for the color and lighting for inspection), and measuring its purity as food grade. The combination of the optical quality and the purity meets the requirement for optical transparency and benigness. In meeting this requiring, it also means particulates are avoided.

### Example 5

### Application of a Cellophane Film for a Permanent Antifogging Coating

A cellophane film permanent coating is prepared by the following steps:
1. An emulsion can be prepared using the procedures outlined in Examples 1 and 2. An emulsion application step includes any of the following processing steps. These processing steps can be used alone or in any number of combinations. Various instruments may be used to ensure adhesion of the gel and/or film on the surface. In the case of a film, use of these instruments may further reduce the air bubbles between the surface and film that interfere with adhesion.
   a. Immersion: This method can be used for bottles, glass panes, and any other surface to be coated or printed with the antifogging solid dry film. The actual parameters for each process such as rates of deposition/coating, drying, repeated applications, optical monitoring, temperature of applied emulsion, coated surfaces, drying environment, external humidity during application and drying are the same.
   b. Immersion and controlled drawing: This is a method that avoids delamination of wet film when withdrawn from emulsion.
   c. Rollers impression: In this processing step or method, rollers, preferably cellophane wrapped, apply emulsion with or without compression from the bottom or from the top, or from both top and bottom on the surfaces of bottles, glass panes, glass jars, etc.
   d. Spray application: The spray is preferably adjusted in droplet dimensions to ensure uniformity of emulsion. In a preferred method, larger drops (>0.1 μm) are used in a shower type as opposed to a thin spray.
   e. Shower/jet application.
   f. Pouring application.
   g. Brush application.
   h. Shaped scraper application. This method involves the use of a “scraper” that is essentially a thin plastic sheet used to distribute the emulsion or film evenly on the surface by applying pressure on the edge.
   i. Film press application.
   j. Compression assisted application. Such an application may involve an instrument referred to as a roller, with a handle and a movable cylinder. The roller is used to apply pressure to the emulsion or film on the surface that is being treated. Other methods of compression can also be a mold specific to the surface that is used to press the emulsion or film onto the surface.
   k. Combined application—The emulsion is mixed with another application, either in bi-layer, which is preferred for simplicity, but it can also be mixed.
   l. Combined in the material used to make the device, be it bottle, container, goggles, etc. in proportion of about 17% or more near the surface to maintain hydrophilicity.
2. In the drying step, it is preferred for effective emulsion adsorption that a low temperature be maintained when the emulsion enters into contact with the surface. A range of appropriate temperatures is 0° C.-48° C. The application and drying steps are generally not repeated.
3. The cellophane can be immersed in the emulsion and applied to the surface of the device, bottler, or package by drawing it over the wet surface. Alternatively, dry or wet cellophane previously immersed in the emulsion can be applied after the surface to be coated has been immersed and cooled in the emulsion using any of the processing steps discussed in step 1. In both cases, compression manually or with rollers or simple sheet or mold compression can be used to make the cellophane uniformly adhere to the whole surface.
4. An essential aspect is to ensure that no air is trapped between the surface to be coated and the cellophane. One way to achieve this is to either draw or soak the surface to be coated in the emulsion and then apply the cellophane with a compressing mold or plate. Another way to ensure that no air is trapped between the surface and the cellophane is to bring the surface and the cellophane into contact in the emulsion, ensuring enough time is given for significant molecular adsorption of the emulsion on both surfaces and compressing then uniformly via a conformal press on the cellophane to the surface, or rollers, or a sheet conformal to the glass or a mold.

### Example 6

### Single Dip or Multiple Dip (Immersion) Processes

When applying the emulsion to a surface by immersion (i.e., by dipping) the following aspects are taken into consideration.
1. The surfaces should be preferably dried before contact with the emulsion to maximize adhesion of the emulsion into a continuous, two-dimensional film.
2. The temperature of the emulsion should be between 0° C.-40° C. to realize a good adhesion of the emulsion and a continuous, smooth coating without beading and adhesion
3. Additionally, it is preferred to immerse and draw surfaces (e.g., the bottles, packages, or panes) an at optimized rate, relatively slowly, around 1 cm/s, so that the top surfaces are cooled at the temperatures of the emulsion and condense the emulsion in a two-dimensional, rather viscous film that remains adherent to the surface without rupturing when emerging from the emulsion.
4. A typical thickness of the emulsion when emerging from the bath is several millimeters. The drawn initial coating thins first quickly by gravitational pull, which removes excess until equilibrium is reached between the cohesive force of the film, the surface tension, and gravity. The typical thickness after drying is in the mm range (e.g., the tenths or hundredths of millimeters) after the water content has been reduced, depending on the number of coats and initial thickness of the wet coating.
5. Therefore, the surfaces should be held as horizontally and as evenly as possible when drawn through the emulsion to maximize wetting and allow a flow as even as possible of emulsion above the initial anchoring molecular adsorbates.
6. For example, bottles are better coated if drawn horizontally in a bath instead of vertically, and “slowly” rolled out of the surface (around 1 cm/s) instead of being “ripped” out of the liquid.
7. Because of the difference in surface tension between concave and convex surfaces, convex surfaces should ideally emerge “face down” and concave surfaces “face up” from the emulsions, and then being held to dry as described herein.
8. Observation and adjustment of the draw rate from the emulsion indicates when the wet coating tends to rupture upon emergence from the bath. This is to be avoided to maximize uniformity and evenness. A typical draw rate is typically in a range around one cm/second. It can be as low as 1 mm/s but should not be faster than 1 m/s. The draw rate may be adjusted by observation for each type of surface. For example, homogeneous surfaces such as glass and polycarbonates tend to coat very evenly without rupture of the wet film at about one cm/second. However, less homogeneous surfaces, surfaces with residues and the presence of prior coatings materials on top of glass and polycarbonates will require slower draw rates and repeated immersions because heterogeneities in the surface cause variation in surface tension, absorption, and rupture of the emulsion film when drawn. The effect is exacerbated upon drying.
9. The smoother and more slippery the surfaces are (such as glass surfaces versus plastic or polymers surfaces) the slower the draw rate should be.
10. When monitoring the immersion process, significant differences are to be observed in rupture rate of the wet coating. Thus, draw rates between different materials vary and need to be noted to adjust a surface material specific draw rate. Hence, for example, identical glass bottles, glass panes or surfaces will need a slower draw rate if they are coated first with another material or if the surface or coating happens to be less homogeneous. A simple optical monitoring of the emerging surface that detects a change of light reflection when the surface emerges and over the next few seconds (3- to 5-second sampling) would be preferred in mass processing to monitor the coating and adjust appropriately for variations.

### Example 7

### Drying Conditions

There are various factors that must be considered when drying the coated surface. Ambient drying proceeds for any length of time from a few minutes to about 24 hours. Drying should take place at a controlled humidity and temperature. For example, drying in a cool environment, such as about 5° C., is used for the emulsion. Alternatively, higher temperatures, including room temperature, are also used for drying.

The use of a cooled, condensing surface next to the drying surfaces increases the rate of drying dramatically. The use of a cooled emulsion and drawing slowly enough to cool the surface helps ensure a more uniform drying after adsorption when drying in a room held at ambient temperature (20° C.-30° C.) by adsorbing further water vapor on the surface layer. This evens surface tension and enhances planarity, surface conformation, and surface smoothness and results in the absence of optical distortion in the film.

When using vented drying, air flowing away from the surface is preferred as blowing towards the surface can lead to distortion of planarity and optical distortion or deformation.

Drying geometry is important for application of the film to objects such as glasses, visors, windshields, windows, mirrors, swim goggles, bottles, and jars. An important parameter in the drying geometry is horizontal drying with the main convex surfaces up, and the main concave surfaces down, to ensure uniform, conformal coatings. Vertical drying with convex and concave surfaces in other orientations may also be employed.

After the initial coat of film has dried on the object's surface, repeated application of the film and drying may be used to create a varnish-like application. A second application of the film may be preferred to ensure complete coverage of the whole surface for certain objects that require it. For example printing applications on bottles might not require a second coat while complete coverage on glass panes may require multiple coats.

### Example 8

### Production of a Emulsion

The following describes a preferred composition and range to create a wet, fluid, water-based, emulsion. This emulsion eliminates detectable droplet formation and optical fogging during fluid condensation. The formation of fluid droplets large enough to interfere with good visualization is eliminated whether the emulsion is wet or dry.

When applied and allowed to dry, the emulsion can create a dry, permanent, solid optical-grade hydrophilic coating, for example the antifogging solid dry film of the present invention, that prevents condensation is one to three parts ratio of the two following components:
1) 1 part non-Newtonian viscoelastic hydrophilic hydrogel, with as uniform as possible polymeric strand lengths, and
2) 3 parts of 2 MΩs deionized water; clarity of emulsions is ensured by using distilled water or 2 MΩs deionized water.
   There should be as little cross-polymerization as possible between the individual polymeric strands when forming the gel to preserve optimum optical transparency and light transmission properties without scattering, as verified by the Tyndale effect. Alternately, there should be as little cross-polymerization as possible if the initial polymer is directly mixed in the aqueous media in the correct proportion for the hydrogel mixed into an aqueous emulsions. For example, a 2% hydrogel (1:50) formation step can be skipped by making directly a [(1:50):3] emulsion.

For permanent antifogging solid dry film creation, a visco-elastic food-grade 86,000 Da cellulosic hydrogel, preferably 2% by volume in deionized water, is used. The initial cellulose polymer should preferably be mostly a well-controlled, food-grade hydroxyproylmethyl cellulose (HPMC) with as little methyl cellulose strands as possible as these are more hydrophobic.

The selected hydrophilic, viscoelastic polymer should be preferably hydrophilic cellulose and should consist of a high percentage of a single kind of uniform polymer chain for consistency and uniformity. In the case of cellulose HPMC, preferably as close as possible to 100% pure HPMC. A range of common binary celluloses mixes, which combine HPMC with methyl-cellulose, may also be used.

The purity for FDA approved food-grade cellulose should be better than 10 ppm in heavy metals, especially for lead (Pb) and arsenic (As). This is preferable to protect users from skin absorption, eye irritation in vision-wear, and for other applications such as direct printing on coatings for food containers.

For applications that do not involve vision-wear, skin contact, or food contacts, any hydrophilic hydrogel can work provided it has the proper viscosity and strand length properties. For vision/food-grade and non-food grade permanent coatings, a mix of two of more different cellulosic gels also function to produce the antifogging solid dry film.

Chemical differences between hydrophilic HPMC and the lighter, more hydrophobic methyl cellulose lie in methoxyl substitution with hydroxypropoxyl and their degree of polymerization which is measured as the 2% solution viscosity. In the preferred, pure form HPMC, the hydroxypropyl substituent group, —OCH₂CH(OH)CH₃ contains a secondary hydroxyl on the number two carbon and may also be considered to form a propylene glycol ether of cellulose. Mixes possess varying ratios of hydroxypropyl and methyl substitution, a factor which influences properties such as organic solubility and the thermal gelation temperature of aqueous solutions. Food-grade reagents ensure good purity and hence both optical transparency and benigness of the coating for vision-wear and eye applications.

Any gel from any polymer can be used, but a preferred range for polymer strands are about 80,000 Da and about 120,000 Da. In some gels, the polymer strands are about 10,000 Da, and in others the strands are about 1,000,000 Da. The emulsion should avoid any other additives in solution such as salts or other substances, which can push the cellulose gel out of solution and affect clarity of the emulsion.

The emulsion should not be too concentrated because the emulsion will be too viscous and will not provide as uniform a coat. More concentrated emulsions can be used in cup-like objects such as goggles and measuring containers provided they are allowed to dry with a free surface to flow. More dilute solutions (e.g., 1:4, 1:5 to 1:7, 1:7 to 1:10, 1:10 to 1:100, 1:100 to 1:3000 volume ratio of solvated viscoelastic polymeric gel to purified water) can be used, but as dilution increases the thickness of the coating decreases. In a preferred embodiment, the viscosity in centipoises ranges from 4000 cP to 1000 cP. At room temperature, the viscosity may be about 250 cP, about 500 cP, about 750 cP, about 1000 cP, about 1500 cP, about 2000 cP, about 2500 cP, about 3000 cP, about 3500 cP, about 4000 cP, about 4500 cP, or about 5000 cP.

### Example 9

### Conducting Optical Measurements

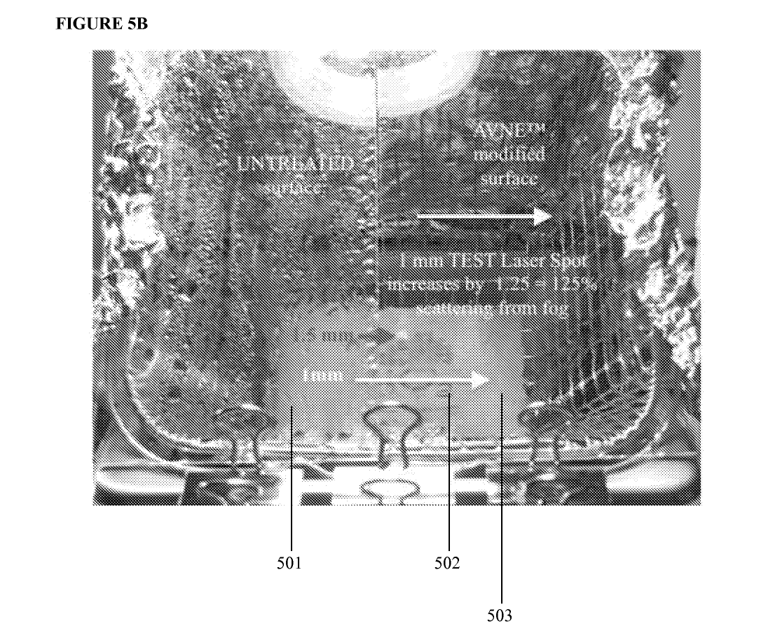

Two glass panels of the same origin were placed over the opening of a container of warm fluid at the same time. After a period of time has passed to produce condensation on the glass panels, the optical distortion by each of the glass panels was measured (FIG. 5).

The untreated panel (501) collected enough condensation to produce water droplet while the treated panel (502) did not. When a coherent laser beam of 1 mm in diameter (503) is passed from the bottom of the warm fluid through the untreated surface, the transmitted laser beam was 9 mm in diameter. Thus there was scattering of 450% from the fog on the untreated panel (501) (FIG. 5A). On the other hand, when the same laser beam of 1 mm in diameter was passed through the treated panel (502), the transmitted laser beam only had a diameter of 1.5 mm (FIG. 5B). Thus the amount of condensation formed on the treated panel (502) only resulted in scattering of 125%. Therefore, not only does treatment of a glass surface with the composition of the present invention reduces condensation and prevent the formation of fog, the treatment produces optical improvement.

### Example 10

### Coating Improves Resistance to Chemical Damage

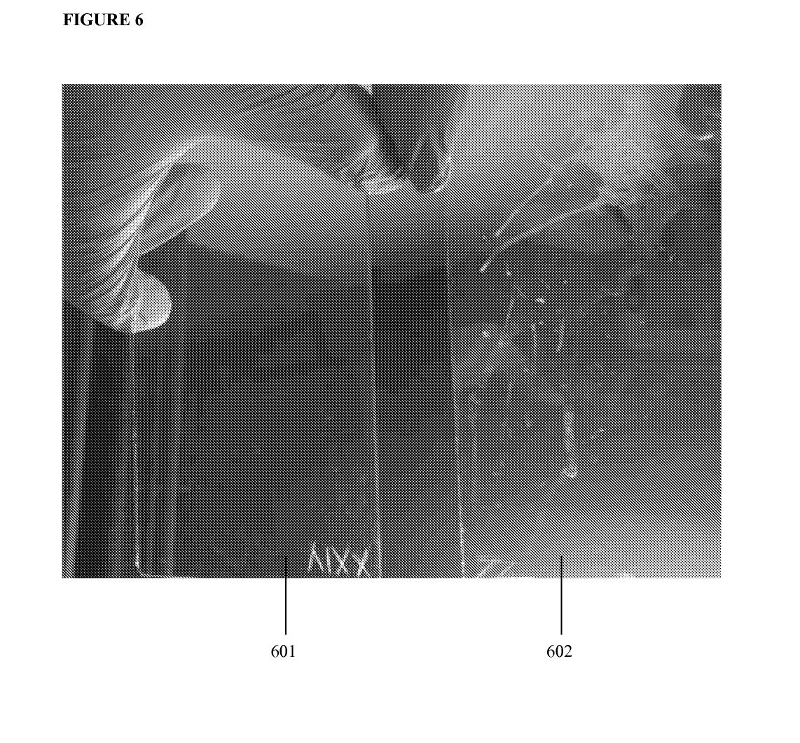

As depicted in FIG. 6, treatment of a common glass surface with the composition and method of the invention improves the glass surface's ability to resist chemical damage. Both glass XXIV (501) and glass XX (502) were exposed to a harsh glass cleaning process where the glass was treated in H₂O₂:NH₃OH mixture in 80° C. The glass surface composition and topography of glass XXIV (501) is intact, as indicated by the clear glass surface. On the other hand, the surface composition and topography of glass XX (502) is heavily and permanently damaged, as indicated by the extraneous material clinging onto the glass surface.

1-51. (canceled)

52. A composition comprising a mixture of:
a solvated viscoelastic polymeric gel, comprising a viscoelastic polymer having a molecular weight of between about 20,000 Da and about 4,000,000 Da; 20,000 Da and about 500,000 Da; or 20,000 Da and about 200,000 Da; and
purified water;
wherein
the volume ratio of gel to water is between about 1:1 and about 1:5 and the composition has a conductivity of less than about 250 μS/m,
the viscoelastic polymer is at least 60% fully hydrated.

53. The composition of claim 52 wherein the purified water has resistivity of between about 60 kΩ-cm to about 17.9 MΩ-cm or about 2 MΩ-cm.

54. The composition of claim 53 wherein the gel has a viscosity of about 500 cP to about 5,000 cP or about 1,000 cP to about 4,000 cP.

55. The composition of claim 54 comprising between 0.0003 wt % and 10 wt % of the viscoelastic polymer, wherein the gel is homogenous and comprises an ester form of a basic cellulose monomer (cellulose ester) or an ether form of a basic cellulose monomer (cellulose ether).

56. The composition of claim 55 wherein
the basic cellulose monomer has a chemical formula C₃₂H₆₀O₁₉ and a molecular weight of 748.8 grams/mole in the stoichiometry C₆H₇O₂(OH)ₓ(OCH₃)_{y}(OC₃H₇)_{z}, wherein x+y+z=3,
the cellulose ester is any one or any combination of cellulose acetate, cellulose triacetate, cellulose butyrate, cellulose propionate, cellulose phthalate, cellulose nitrate, cellulose sulfate, cellulose phosphate, cellulose acetate propionate, cellulose acetate butyrate, cellulose acetate phthalate, and cellulose nitrate acetate, and
the cellulose ether is any one or any combination of methyl cellulose, ethyl cellulose, ethyl methyl cellulose, benzyl cellulose, hydroxyethyl cellulose, hydroxypropyl cellulose (HPC), hydroxyethyl methyl cellulose, hydroxypropyl methyl cellulose (HPMC), ethyl hydroxyethyl cellulose, and carboxymethyl cellulose (CMC).

57. The composition of claim 56 wherein the gel comprises a glycosaminoglycan that comprises a material that is any one or any combination of hyaluronan, heparan sulfate, heparin, keratan sulfate, dermatan sulfate, and chondroitin sulfate.

58. A method of producing an antifogging solid dry film comprising:
forming a solvated viscoelastic polymeric gel comprising a viscoelastic polymer having a molecular weight of between about 20,000 Da and about 4,000,000 Da and comprising a cellulose ester, a cellulose ether, or a glycosaminoglycan;
generating an emulsion comprising the gel and purified water wherein
the volume ratio of the gel to the purified water is between about 1:1 and about 1:5 or between about 1:2 and about 1:3,
the emulsion has a conductivity of less than about 250 μS/m,
the purified water has a resistivity of between about 60 kΩ-cm to about 17.9 MΩ-cm or about 2 MΩ-cm;
applying the emulsion to a surface;
and
drying the emulsion on the surface to produce the antifogging solid dry film.

59. The method of claim 58 wherein the applying and drying steps are repeated to produce multiple emulsion coats.

60. The method of claim 59 wherein the applying step comprises:
immersing the surface in the emulsion and drawing the surface out of the emulsion at a rate between about 1 millimeter/s and about 1 meter/s or about 1 millimeter/s and about 1 centimeter/s;
impressing the emulsion onto the surface with a roller;
spraying the emulsion onto the surface;
showering or jetting the emulsion onto the surface;
pouring the emulsion onto the surface;
or
brushing the emulsion onto the surface.

61. The method of claim 60 wherein drying the emulsion on the surface is performed at a temperature of from about 0° C. to about 48° C. or about 5° C. to about 15° C.

62. The method of claim 61 further comprising applying:
ink that comprises a material that is any one or any combination of an offset ink, a flexographic ink, an energy-curable ink, a gravure ink, a letterpress ink, or a specialty ink to the dry film;
or
paint to the dry film,
wherein the ink is an energy-curable ink selected from the group consisting of an ultraviolet (UV) ink and an electron beam (EB) ink.

63. A method of applying an antifogging solid dry film comprising:
attaching the film to a first surface with a first binding agent comprising a material that is any one or any combination of the composition of claim 52, an optically satisfactory gluing agent, or water;
and
moving the film to a second surface and binding it to the second surface with a second binding agent comprising a material that is any one or any combination of the composition of claim 52, an optically satisfactory gluing agent, or water,
wherein the first binding agent is the same as the second binding agent or the first binding agent is not the same as the second binding agent.

64. A device comprising an antifogging coating, the antifogging coating comprising the composition of claim 52.

65. The device of claim 64 wherein the antifogging coating coats a surface of:
a windshield or mirror of an automobile, motorcycle, boat, airplane, or train;
a pair of goggles, a camera lens, a corrective lens, a facial mask, a facial shield, a helmet, a visor, an endoscope, a laparoscope, an arthroscope, an intraocular lens;
or
a bottle or package.

66. The device of claim 65 wherein the antifogging coating further comprises a layer of transparent film comprising a material that is any one or any combination or cellophane, cellulose acetate, poly(methyl methacrylate), polycarbonate, polyethylene, polyethylene terephthalate, polylactic acid, or polyvinyl butyral.

67. A method comprising nano-etching a surface to create a texture with
a horizontal maximum feature of less than about 200 nm
and
an average roughness root mean square of less than about 0.4 nm,
wherein the texture inhibits water molecules from forming a fog on the surface.

68. The method of claim 67 wherein the nano-etching uses a liquid phase or a vapor phase etching agent that comprises a material that is any one or any combination of hydrofluoric acid, buffered hydrofluoric acid, nitric acid, hydrogen peroxide, phosphoric acid, buffered oxide etch, potassium hydroxide, ethylenediamine pyrocatechol, tetramethylammonium hydroxide, aqua regia, sulfuric acid, iodine and potassium iodide solution, hydrochloric acid, citric acid, or acetic acid.

69. The method of claim 68 further comprising:
treating the surface with a hydrophilic molecular adsorbate is a material comprising polyethylene oxide or HPMC,
wherein the hydrophilic molecular adsorbate allows the water molecules to interact with the surface to form a continuous film without any optically detectable air.
